(19) United States
(12) Patent Application Publication
(10) Pub. No.: US 2018/0108056 A1
(43) Pub. Date: Apr. 19, 2018

(54) ONLINE MANAGEMENT SYSTEM AND METHODS

(71) Applicant: Crispen Chikuvadze, Dubai (AE)

(72) Inventor: Crispen Chikuvadze, Dubai (AE)

(21) Appl. No.: 15/295,500

(22) Filed: Oct. 17, 2016

(51) Int. Cl. G06Q 30/04; G06F 19/00; G06Q 50/26; G06Q 30/02; G06Q 40/00; G06Q 20/40; G06Q 50/34; G06Q 30/00; G07F 17/32

(52) U.S. Cl. CPC G06Q 30/04; G06F 19/322; G06Q 50/26; G06Q 30/0283; G06Q 40/12; G07F 17/3258; G06Q 50/34; G06Q 30/0185; G06Q 30/0202; G07F 17/329; G06Q 20/405

(57) ABSTRACT

A networked system used to implement online transactions and communication between users. The users are account holders at banks located in a plurality of countries. The banks are connected to a computing system, which may be configured to implement a number of different transactions between users.

### BACKGROUND OF THE INVENTION

### Field of the Invention

The present invention is directed generally to computing systems for conducting electronic transactions.

### Description of the Related Art

Many users, including companies, conduct transactions online. Unfortunately, these transactions may be complicated particularly when users are physically located in different countries. Therefore, a need exists for new systems and methods for conducting online transactions. Systems and methods configured to enable transactions between users in different countries would be particularly desirable. The present application provides these and other advantages as will be apparent from the following detailed description and accompanying figures.

### BRIEF DESCRIPTION OF THE SEVERAL VIEWS OF THE DRAWING(S)

FIG. 1 is an illustration of a networked system used to implement online transactions and communication between users.

FIG. 2 is an illustration of multiple countries and examples of banks located in those countries.

FIG. 3 is a flow diagram of a method of setting up a computing system of the networked system of FIG. 1 to conduct transactions between the users.

FIG. 4 is a block diagram of accounts on the computing system and their relationship to bank accounts.

FIG. 5 is a block diagram showing a plurality users with access to a company account.

FIG. 6 is a flow diagram of a method of implementing a bidding or quotation process.

FIG. 7 is a flow diagram of a method of implementing an invoicing and release of funds process.

FIG. 8 is a flow diagram of a method of implementing a purchasing process.

FIG. 9 is a flow diagram of a method of implementing a payment.

FIG. 10 is a flow diagram of a method of determining whether a parking fee has been paid for a particular vehicle for a parking location and ticketing the vehicle if the fee was not paid.

FIG. 11 is a flow diagram of a method performed by human resources users.

FIG. 12 is a flow diagram of a method of processing requests submitted by employees.

FIG. 13 is a block diagram showing a main government account and sub-organization accounts.

FIG. 14 is a diagram of a hardware environment and an operating environment in which the computing devices of the system of FIG. 1 may be implemented.

FIG. 15 is a flow diagram of a payment process.

FIG. 16 is a block diagram of bank accounts associated with users Mark and John.

FIG. 17 is a block diagram illustrating all routes by which funds might be sent from John's account at a Bank XXX to each of Mark's accounts and includes costs associated with each of the routes.

FIG. 18 is an illustration of an exemplary funds transfer interface.

FIG. 19 is a block diagram illustrating a government account and users with access thereto.

FIG. 20 is a flow diagram of a method of transferring funds from a first user to a second user.

FIG. 21 illustrates an exemplary matrix for a particular jurisdiction that may be used by the jurisdiction when making decisions.

FIG. 22 is a flow diagram illustrating tracking raw materials.

Like reference numerals have been used in the figures to identify like components.

### DETAILED DESCRIPTION OF THE INVENTION

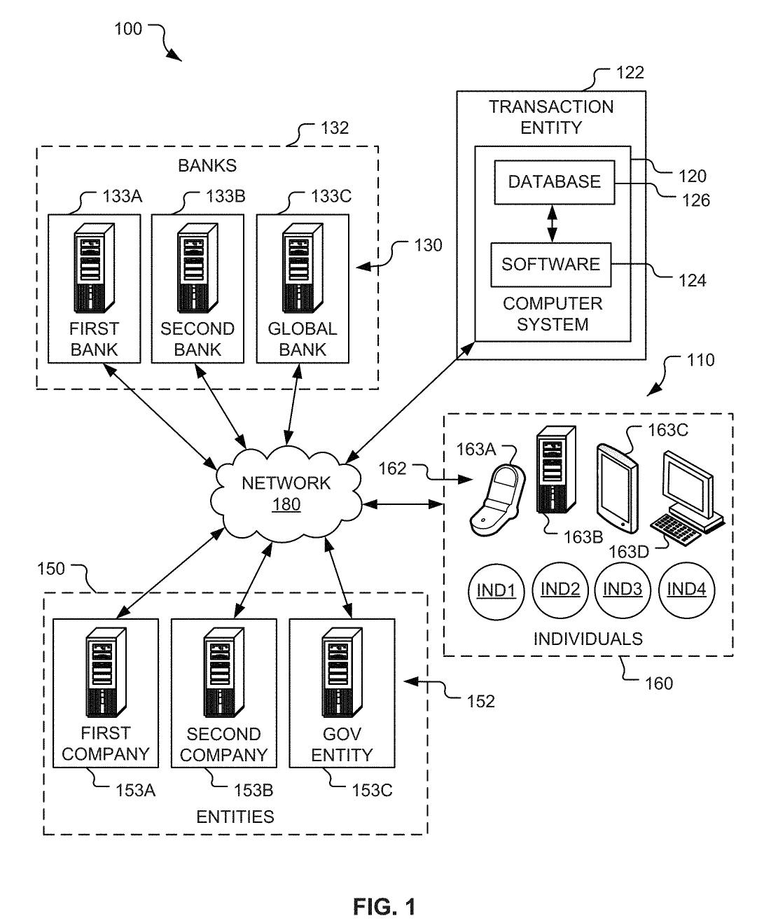

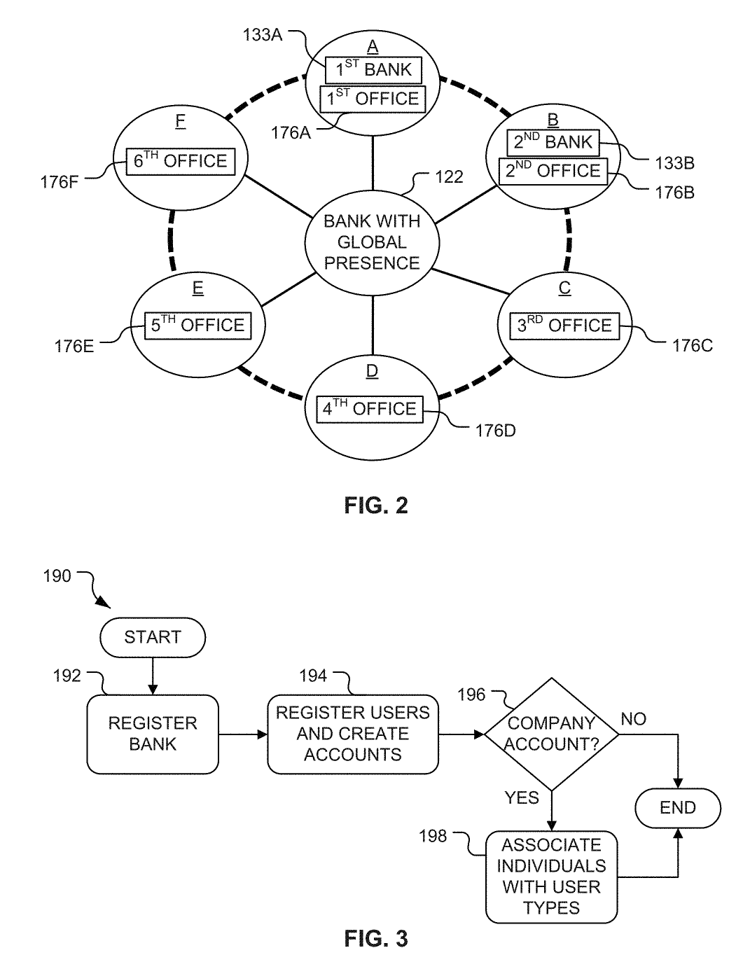

FIG. 1 depicts a networked system 100 used to implement online transactions (e.g., searching, processing, and paying) and communication between users 110. The system 100 includes a computing system 120 operated by a transaction entity 122. The computing system 120 implements transaction software 124 and, optionally, a database 126. The transaction software 124 is configured to store data in and retrieve data from the database 126, when present. As shown in FIG. 2, the transaction entity 122 may be a bank with a global presence. On the other hand, the transaction entity 122 may provide some of the functionality of a global bank but need not actually be a bank.

Returning to FIG. 1, the system 100 includes a plurality of banking computing systems 130 operated by different banks 132. The banks 132 may be located in different countries A-F (see FIG. 2) around the world. Each of the banks 132 may or may not have a global presence. For ease of illustration, in FIG. 1, the banks 132 include a first bank 133A located in the country A (see FIG. 2), a second bank 133B located in the country B (see FIG. 2), and a global bank 133C (which has a global presence). However, the banks 132 may include any number of banks each like one of the banks 133A-133C.

Some of the banks 132 may have one or more different offices or branches. Referring to FIG. 2, the global bank 133C (see FIG. 1) may have branches/offices 176A-176F located in more than one of the countries A-F. In the example illustrated in FIG. 2, the offices 176A-176F of the global bank 133C (see FIG. 1) are located in the countries A-F, respectively. While FIG. 2 illustrates only six different countries, the system 100 may be used with any number of different countries or jurisdictions.

Returning to FIG. 1, the users 110 include entities 150 and individuals 160. By way of non-limiting examples, the entities 150 may include one or more governmental organizations (e.g., a government entity 153C, which may be implemented as a government, a government department, a government authority, and the like) and/or private organizations (e.g., companies 153A and 153B, non-profit organizations, and the like). For ease of illustration, the entities 150 have been illustrated as including the three entities (namely, the companies 153A and 153B and the government entity 153C) and the individuals 160 have been illustrated as including four individuals IND1-IND4. However, the system 100 may be used by any number of entities and/or individuals.

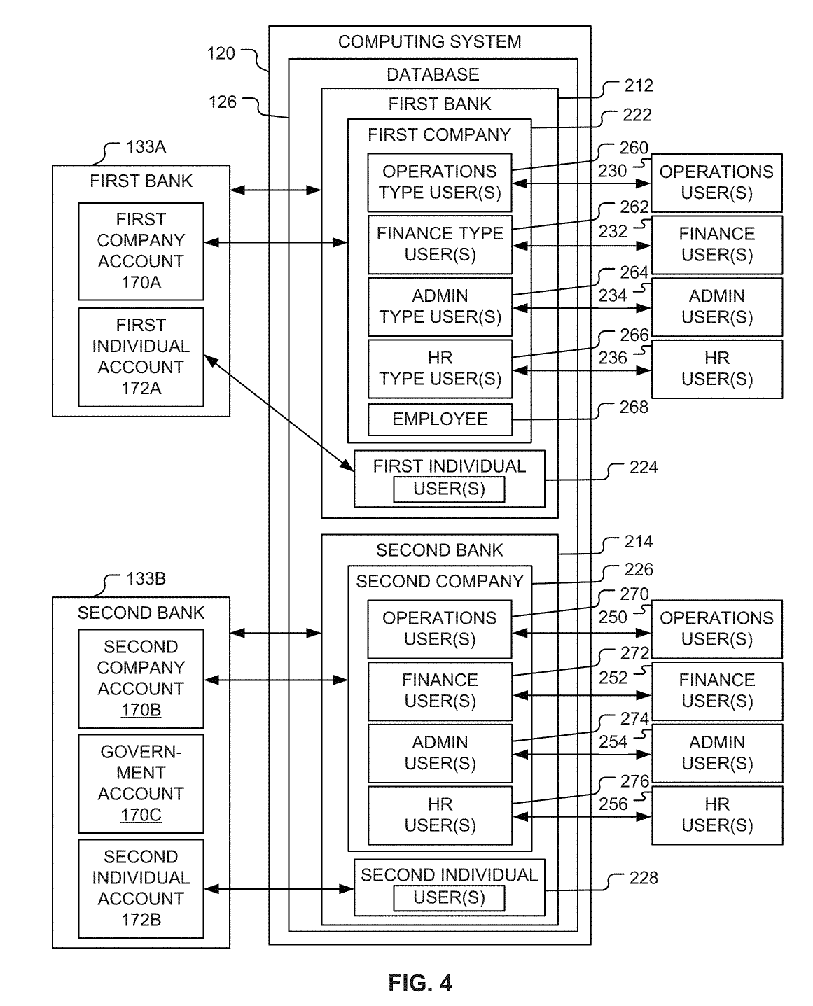

The users 110 are account holders or customers of the banks 132. Referring to FIG. 4, by way of a non-limiting example, the first company 153A has a first company account 170A at the first bank 133A and the individual IND1 has a first individual account 172A at the first bank 133A. Similarly, in the example illustrated, the second company 153B has a second company account 170B at the second bank 133B, the government entity 153C has a government account 170C at the second bank 133B, and the individual IND2 has a second individual account 172B at the second bank 133B.

Returning to FIG. 1, the individuals 160 access the computing system 120 using computing devices 162. For ease of illustration, in FIG. 1, the individuals IND1-IND4 operate computing devices 163A-163D, respectively. The individuals IND1 and IND2 may access their individual accounts 172A and 172B (see FIG. 4), respectively, using the computing devices 163A and 163B, respectively. The first company 153A, the second company 153B, and the government entity 153C may use computing systems 152 to access their accounts 170A-170C (see FIG. 4), respectively.

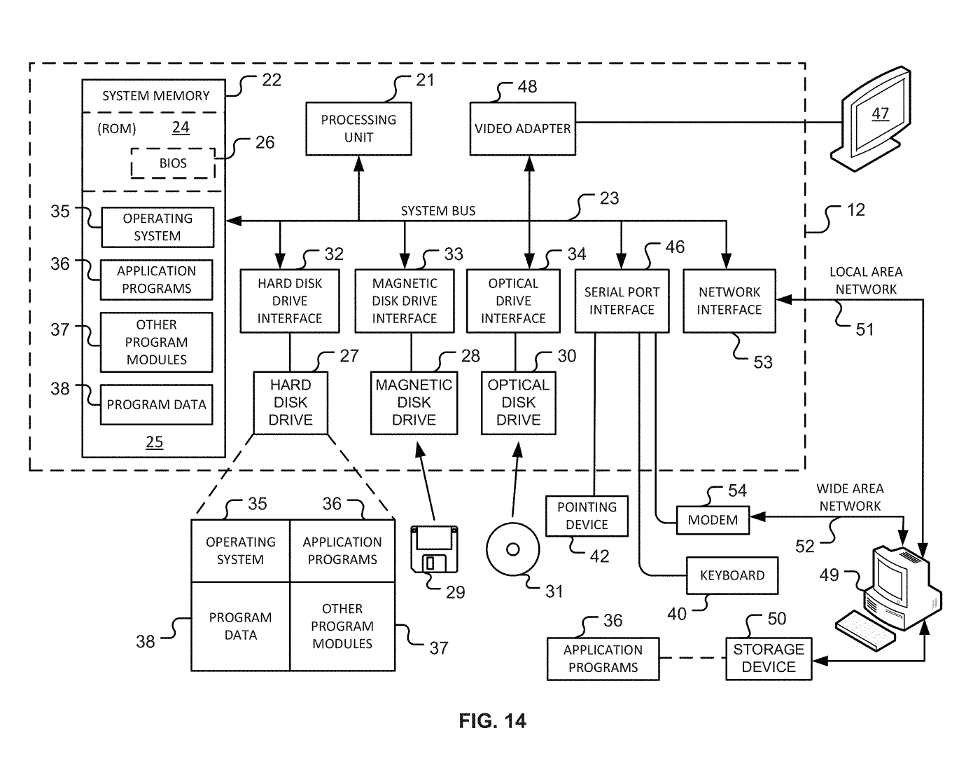

The computing systems 120, 130, and 152 and the computing devices 162 are all interconnected by a network 180 (e.g., the Internet). Each of the computing systems 120, 130, and 152 and the computing devices 162 may each be implemented as a computing device 12 (see FIG. 14) described below.

FIG. 3 is a method 190 of setting up the computing system 120 (see FIGS. 1 and 4) to conduct transactions between the users 110 (see FIG. 1). In first block 192, referring to FIG. 1, the banks 132 use the computing systems 130 to register with the computing system 120 (e.g., upon fulfilling particular terms and conditions). Referring to FIG. 4, for each bank registered, the software 124 (see FIG. 1) may create a record in the database 126. By way of non-limiting example, FIG. 4 shows records 212 and 214 created for the first and second banks 133A and 133B, respectively, when they were registered with the computing system 120.

Returning to FIG. 3, in block 194, the users 110 (the entities 150 and the individuals 160 illustrated in FIG. 1) are registered with the computing system 120 (see FIG. 1). For each user registered, the software 124 (see FIG. 1) creates an individual account and/or a company account (e.g., in the database 126) and assigns a unique user identification (“ID”) to the user. The user ID may be used to make payments (from an account associated with the user ID) to other users within the same country or anywhere in the world.

By way of non-limiting example, FIG. 4 shows a first company account 222 created by the software 124 (see FIG. 1) for the first company 153A (see FIG. 1) and a first individual account 224 created by the software 124 for the individual IND1 (see FIG. 1). As shown, the computing system 120 associates both the first company account 222 and the first individual account 224 with the first bank 133A. The computing system 120 also associates the first company account 170A and the first individual account 172A with the first company account 222 and the first individual account 224, respectively. Using these relationships, the software 124 (see FIG. 1) may instruct the first bank 133A to freeze and/or release a portion of the funds in the first company account 170A and/or the first individual account 172A.

Similarly, FIG. 4 shows a second company account 226 created by the software 124 (see FIG. 1) for the second company 1536 (see FIG. 1) and a second individual account 228 created by the software 124 for the individual IND2 (see FIG. 1). As shown, the computing system 120 associates both the second company account 226 and the second individual account 228 with the second bank 133B. The computing system 120 also associates the second company account 170B and the second individual account 172B with the second company account 226 and the second individual account 228, respectively. Using these relationships, the software 124 (see FIG. 1) may instruct the second bank 1336 to freeze and/or release a portion of the funds in the second company account 1706 and/or the second individual account 1726.

Optionally, in block 194, the banks 133A and 133B may upload and register their users with the computing system 120. Alternatively, the banks 133A and 1336 may input lists of their users and those users may register themselves. The individuals 160 (see FIG. 1) may register personal information (such as physical address and phone number(s)) and the entities 150 (see FIG. 1) may register entity information (such as identities of directors and shareholders).

While an individual account (e.g., the first individual account 224) may be accessed by a single type of user (e.g., the individual IND1 illustrated in FIG. 1), a company account (e.g., the first company account 222) may be accessed multiple types of users (or employees) with different roles or functionality with respect to the company. In decision block 196, a decision is made whether each new account is a company account. The decision in decision block 196 is “NO,” when the new account is an individual account and the method 190 terminates.

On the other hand, the decision in decision block 196 is “YES,” when the new account (e.g., the first company account 222) is a company account. When the decision is “YES,” in block 198, one or more of the individuals 160 (e.g., employees) are associated with each user type. Each individual associated with a user type has access to the company account. Further, the funds in the company account may be divided or allocated between the different user types.

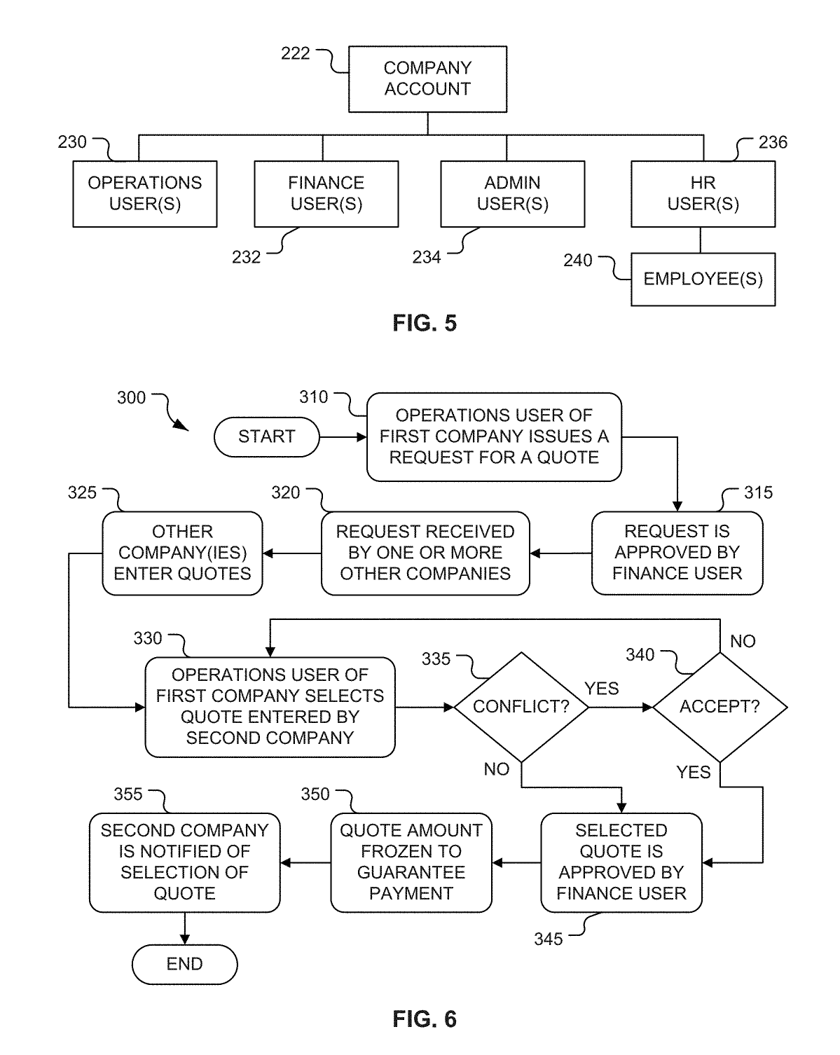

By way of an example, referring to FIG. 5, four different user types may be associated with a particular company account (e.g., the company account 222): operations user type, finance user type, administrative user type, and human resources (“HR”) user type. One or more individuals may be associated with each user type. Thus, as shown in FIG. 5, the company account 222 may be accessed by one or more operations users 230, one or more finance users 232, one or more administrative users 234, and one or more HR users 236. The users 230-236 may work for an operations department, a finance department, an administration department, and a HR department, respectively. However, this is not a requirement. Similarly, referring to FIG. 4, the second company account 226 may be accessed by one or more operations users 250, one or more finance users 252, one or more administrative users 254, and one or more HR users 256.

Referring to FIG. 4, for each individual associated with a user type, the computing system 120 creates a record in the database 126. By way of non-limiting example, FIG. 4 shows records 260-266 created for the users 230-236, respectively, and records 270-276 created for the users 250-256, respectively.

Referring to FIG. 5, the HR user(s) 236 may connect other employees 240 to the company account 222. In other words, the employees 240 may be registered with the computing system 120 by the HR user(s) 236. Thus, the users 230-236 may connect (or communicate) with the employees 240 via the company account 222 and/or individual accounts held by the employees 240 (and registered with the computing system 120).

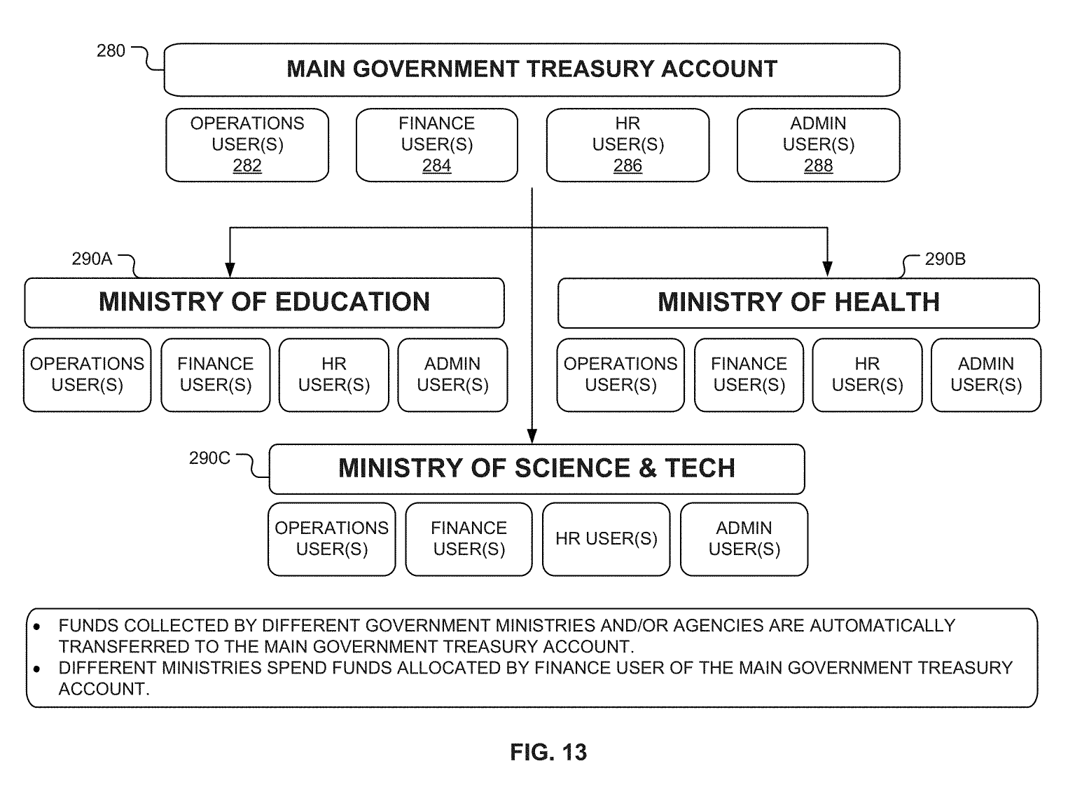

Referring to FIG. 1, as mentioned above, the entities 150 may include governmental organizations (e.g., the government entity 153C). If the government entity 153C is a government or a treasury, the government entity 153C may set up (using the method 190 illustrated in FIG. 3) a main government account 280 (see FIG. 13) for use by multiple user types. For example, referring to FIG. 13, the main government account 280 (labelled “main government treasury account”) may be set up for use by operations, finance, administrative, and HR users 282-288. Similarly, the governments of each of the countries A-F (see FIG. 2) may each have a main government account (like the main government account 280) and relationships (or associations) may be set up for sub-organizations (e.g., ministries, agencies, and the like) within the government. For example, the main government account 280 may create replica accounts 290A-290C (referred to as “sub-organization accounts”) in the computing system 120 for different accounts held by the sub-organizations. Referring to FIG. 4, the sub-organization accounts 290A-290C may operate like the company accounts 222 and 226; however, funds received by the different sub-organizations may be credited to the main government account 280 of the government (e.g., controlled by the treasury). As shown in FIG. 13, the employees of the various ministries and/or agencies within a particular governmental organization may be registered as operations, finance, administrative, and HR users. The main government account 280 may allocate funds to the sub-organizations (e.g., to the sub-organization accounts 290A-290C) for their expenditures (which may be allocated by one or more of the finance user(s) 284). Thus, the sub-organizations can only spend the funds allocated by the government.

Referring to FIG. 1, after the entities 150 have each registered, they can connect with other users (e.g., their other branches, outlets, and partners both locally and in other countries). The entities 150 may specify relationships (in the computing system 120) between themselves and other users 110. For example, one of the entities 150 may specify whether another user 110 (e.g., a particular branch) is a subsidiary, a parent company, a branch, a partner, joint venture, and the like. The entities 150 may assign rights to related users 110 (e.g., branches, outlets, partners, and the like) anywhere in the world. By way of non-limiting examples, the rights assigned may include one or more of the following;
1. rights to approve quotes and payments;
2. viewing rights only;
3. no rights (just connection); and
4. viewing rights to certain selected information;
   By way of non-limiting examples, connected or related users may include hospitals and medical insurance companies, different airlines sharing a loyalty program, and the like. By way of another non-limiting example, related entities (e.g., different branches of the same company) may send communications to one another. For example, a first branch may send an inquiry to a second branch as to whether the second branch would like to take advantage of a supplier discount by combining a first purchase of the first branch with a second purchase of the second branch.

The users 110 (e.g., the individual IND3) may delegate responsibilities to one or more other user(s) (e.g., the individual IND4). For example, the individual IND3 may delegate responsibilities to the individual IND4 before the individual IND3 goes on leave. The individual IND3 may input a start date and an end date of the leave, select the individual IND4 (by the user ID assigned to the individual IND4), and enter a selection indicating that the individual IND3 is delegating responsibilities to the individual IND4. The individual IND4 receives a password that will be valid for the duration of the leave. During this time, the individual IND4 may perform all the functions assigned to the individual IND3. For example, if the individual IND3 is one of the operations user(s) 230 (see FIG. 4) and the individual IND4 is one of the finance user(s) 232 (see FIG. 4), the individual IND4 may perform the duties of the operations user(s) 230 as well as the duties of the finance user(s) 232. The individual IND3 may choose to receive notifications from the computing system 120 during the leave.

The computing system 120 may be characterized as grouping bank accounts (e.g., held in different countries) and allowing the users 110 of these bank accounts to transfer funds or make payments to other users of the computing system 120. The computing system 120 also allows the users 110 to communicate with another. For example, an insurance company user of the computing system 120 may obtain a confirmation or other information (e.g., a police report) from another user (e.g., a police department) of the computing system 120 before making a payment to an insured user of the computing system 120.

Further, users may connect their accounts to one or more other accounts and share information therebetween. A first user of a connected account may view information regarding the other connected account(s) (as permitted by the user(s) of the account(s)) and may, for example, approve quotes, approve payments, and generate (and view) reports using the computing system 120.

Additionally, users may assign rights (e.g., right to approve payments) to other users and/or confirm actions taken by other users. For example, a first user may select a second user (e.g., a lawyer) to confirm fulfilment of a condition. After this condition is satisfied (e.g., a transfer of property has occurred), funds may be released (or transferred to another user).

Day to-day business activities of a user (e.g., the first company 153A) may be connected to the user's account (e.g., the first company account 222) implemented by the computing system 120 and the computing system 120 may record such business activities. For example, tickets booked by an airline company may be connected with its bank account (via a company account on the computing system 120). At the same time, one of these tickets booked by an individual may be connected with the individual's bank account (via an individual account on the computing system 120). This information may be used to provide information (e.g., a flight schedule) to the individual and/or others.

After the users 110 (who may be located around the world) have been registered, they may perform one or more of the methods 300-900 illustrated in FIGS. 6-12, respectively.

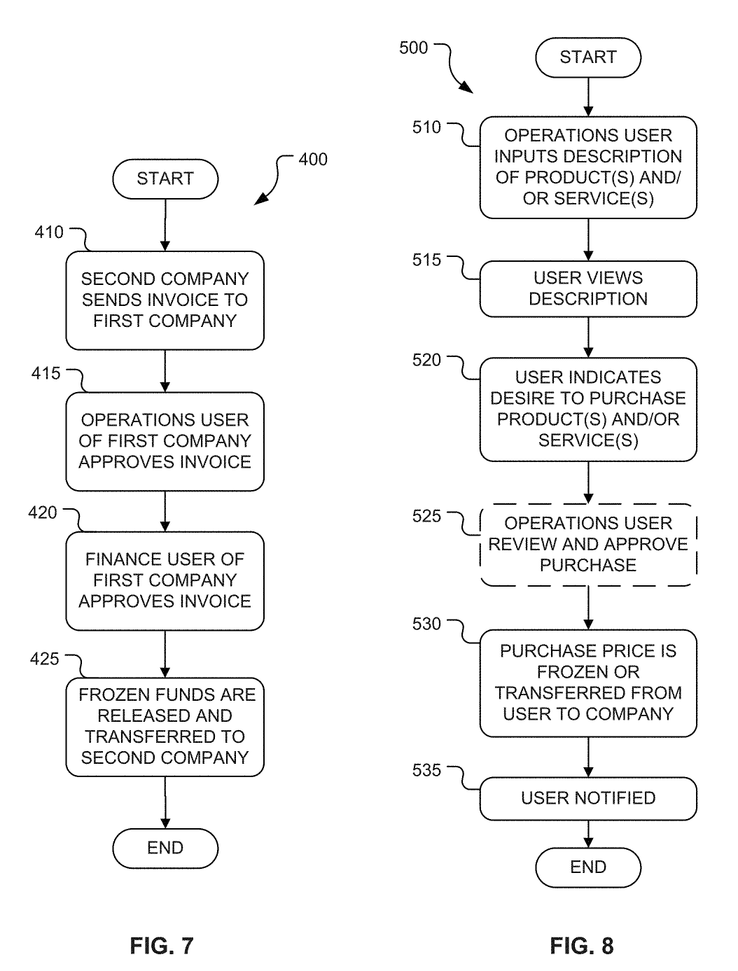

The method 300 (see FIG. 6) implements a bidding or quotation process and the method 400 (see FIG. 7) implements an invoicing and release of funds process. For ease of illustration, the methods 300 and 400 will be described as being performed by the first and second companies 153A and 153B (see FIG. 1). Before the methods 300 and 400 are performed, the operations user(s) 250 may enter or upload a description of the types of products and/or services offered by the second company 153B (see FIG. 1).

Referring to FIG. 6, in first block 310, one or more of the operations users 230 (see FIG. 4) of the first company 153A (see FIG. 1) issues a request for a bid or quote. This request is entered into the computing system 120 (e.g., via one of the computing systems 152 illustrated in FIG. 1). The request includes a description of one or more products and/or services the first company 153A wishes to purchase.

In next block 315, the request is approved by one or more of the finance users 232 (see FIG. 4) of the first company 153A (see FIG. 1). After the request is approved, the computing system 120 (see FIGS. 1 and 4) notifies other relevant companies (e.g., the second company 153B illustrated in FIG. 1) of the request. The computing system 120 may determine which companies to notify of the request based on the descriptions of the types of products and/or services entered by the second company 153B.

In next block 320, the relevant companies (e.g., the second company 153B illustrated in FIG. 1) review the request. The request is associated with the user ID of the first company 153A. Optionally, in the request, the first company 153A may be identified by only its user ID. In block 320, the computing system 120 displays the request to the relevant companies (via the computing systems 152 illustrated in FIG. 1). The computing system 120 also displays an input (e.g., a quotation box) into which the companies may enter a quote. The input may be viewable for at least two working days excluding weekends. The input may be viewable by those users registered (or associated) with the relevant companies. By way of a non-limiting example, the input may be viewable by the users 250-256 (see FIG. 4) registered with the second company 153B and the users registered with other companies. Optionally, both the request and the input are viewable by all users.

In block 325, those of the relevant companies wishing to respond to the request enter a quote (that includes a monetary price amount) into the input. By way of a non-limiting example, the operations users 250 (see FIG. 4) of the second company 153B (see FIG. 1) may enter a quote. The quote is associated with the user ID of the second company 153B. Optionally, in the quote, the second company 153B may be identified by only its user ID.

In block 330, the operations users 230 (see FIG. 4) of the first company 153A (see FIG. 1) review any quotes received in response to the request and select a quote from one of the relevant companies (e.g., the quote entered by the second company 153B).

If there are any potential conflicts of interest, the decision in decision block 335 is “YES.” Otherwise, the decision in decision block 335 is “NO.” By way of a non-limiting example, a conflict occurs when the selected company has one or more directors in common with the first company 153A.

When the decision in decision block 335 is “YES,” in decision block 340, the operations users 230 (see FIG. 4) of the first company 153A (see FIG. 1) determine whether the conflict is acceptable. The decision in decision block 340 is “YES” when the conflict is acceptable. Otherwise, the decision in decision block 340 is “NO.” If the decision in decision block 340 is “NO,” the operations users 230 of the first company 153A select a different quote in block 330.

If the decision in decision block 335 is “NO” or the decision in decision block 340 is “YES,” in block 345, the selected quote is approved by one or more of the finance users 232 of the first company 153A.

In block 350, the computing system 120 instructs the first bank 133A to freeze (or hold) the price amount of the quote in the first company account 222 (see FIG. 4) to guarantee payment by the first company 153A (see FIG. 1).

In block 355, the company (e.g., the second company 153B) that supplied the quote that was selected in block 330 (the “selected company”) is notified of the selection. Then, the method 300 terminates.

After the method 300 terminates, the selected company supplies the one or more products and/or services described in the request.

As mentioned above, the method 400 implements the invoicing and release of funds process. Referring to FIG. 7, in first block 410, the selected company (e.g., the second company 153B illustrated in FIG. 1) enters an invoice into the computing system 120 (see FIGS. 1 and 4) after supplying the one or more products and/or services described in the request. The computing system 120 sends the invoice to the first company 153A (see FIG. 1). Optionally, in the invoice, the first company 153A may be identified by only its user ID.

In next block 415, the invoice is reviewed and approved by one or more of the operations users 230 (see FIG. 4) of the first company 153A using the computing system 120.

In next block 420, the invoice is reviewed and approved by one or more of the finance users 232 (see FIG. 4) of the first company 153A (see FIG. 1) using the computing system 120.

In block 425, the computing system 120 instructs the first bank 133A (see FIGS. 1 and 4) to release the frozen (or held) funds (totaling the price amount of the quote) from the first company account 222 (see FIG. 4) and transfer these funds to the second company account 226 (see FIG. 4).

Then, the method 400 terminates.

Thus, together, the methods 300 and 400 (see FIGS. 6 and 7, respectively) implement a bidding and payment process in which the computing system 120 requests that the relevant bank freeze the payment (in the quote amount) before the product(s) and/or service(s) are delivered. Then, after the product(s) and/or service(s) are delivered, the invoice is processed and approved. Finally, the frozen funds are released and paid to the appropriate user.

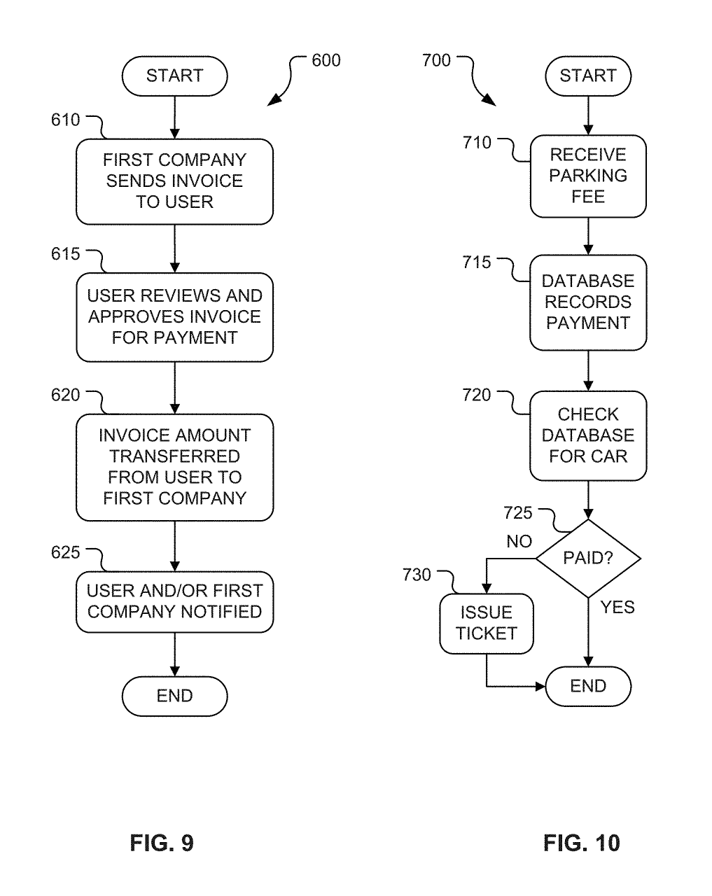

The method 500 (see FIG. 8) implements a purchasing process and the method 600 (see FIG. 9) implements a payment process using the computing system 120. For ease of illustration, the methods 500 and 600 will be described as being performed by the first company 153A and the individual IND2 (see FIG. 1).

Referring to FIG. 8, in first block 510, the operation user(s) 230 (see FIG. 4) enter descriptions of products and/or services and associated prices of each into the computing system 120.

In block 515, the individual IND2 views the descriptions, which are displayed by the computing system 120.

In block 520, the individual IND2 indicates a desire to purchase one or more of the products to and/or services the computing system 120 and the computing system 120 sends a notification to the first company 153A. Optionally, in the notification, the individual IND2 may be identified by only the user ID assigned to the individual IND2.

In optional block 525, the operation user(s) 230 may review and approve the purchase.

Then, in block 530, the computing system 120 instructs the second bank 1336 (see FIGS. 1 and 4) to either freeze (or hold) the purchase price in the second individual account 228 (see FIG. 4) to guarantee payment to the first company 153A or transfer the purchase price from the second individual account 228 (see FIG. 4) to the first company account 222 (see FIG. 4).

In block 535, the individual IND2 may be notified of the status of the purchase and/or payment. Then, the method 500 terminates. After the method 500 terminates, the first company 153A delivers the product(s) and/or performs the service(s).

As mentioned above, the method 600 (see FIG. 9) implements a payment process. Referring to FIG. 610, the first company 153A sends an invoice via the computing system 120 to the individual IND2. Optionally, in the invoice, the individual IND2 may be identified by only the user ID assigned to the individual IND2 and/or the first company 153A may be identified by only its user ID.

In next block 615, the individual IND2 reviews the invoice (displayed by the computing system 120) and approves payment of the invoice.

In block 620, the computing system 120 instructs the second bank 1336 to transfer the invoice amount from the second individual account 228 (see FIG. 4) to the first company account 222 (see FIG. 4). If the method 600 is being performed after the method 500 and, in block 530, the bank 133B froze (or held) funds, in block 620, the computing system 120 instructs the second bank 133B to release the frozen (or held) funds (totaling the invoice amount) and transfer the invoice amount from the second individual account 228 (see FIG. 4) to the first company account 222 (see FIG. 4).

Then, in block 625, the individual IND2 and/or the first company 153A are notified of the transfer. Then, the method 600 terminates.

Thus, using the methods 300-600 illustrated in FIGS. 6-9, respectively, the users 110 (see FIG. 1) can make payments, receive funds, and/or seek quotations from other registered users anywhere in the world. Optionally, all of these functions may be performed using only the user IDs of the relevant users. Delivery of quoted price amounts are guaranteed because the computing system 120 automatically instructs the banks 132 to freeze the funds and release them after the product(s) and/or service(s) has been provided. The net payables between the different banks 132 and/or countries may be settled internally by the banks 132. Optionally, funds transfer and payments (including international transfers) may be implemented using only the recipient's user ID. Thus, the transfer of funds is easier than prior art methods that require swift codes, account numbers, and/or International Bank Account Numbers (“IBANs”). Optionally, a first user may purchase a product or service using the user ID of another second user provided the second user approves the purchase (e.g., using one of the computing devices 162).

Whenever one of the users 110 makes a purchase using the computing system 120, the computing system 120 records one or more of the following pieces of information and associates this information with the relevant account(s) on the computing system 120:
1. Search criteria used to identify relevant requests for quotes;
2. Search results;
3. Details included in requests for quotes;
4. Users from which quotes were requested;
5. Users excluded from quote process;
6. Quotes received;
7. Details related to selected quotes (including the user(s) who selected the quotes and the user(s) who approved the selection);
8. Invoices received; and
9. The user(s) who approved the invoices.

Information recorded by the computing system 120 may be recalled and viewed by the user(s) associated with the information.

### Operations User(S)

Referring to FIG. 4, the operations user(s) 230 and 250 are generally responsible for the core business activities of the first and second companies 153A and 1536 (see FIG. 1), respectively. Thus, the function(s) of the operations user(s) 230 and 250 depend upon the core business of the first and second companies 153A and 1536, respectively. For the sake of brevity, the functions performed by the operations user(s) 250 are described below. However, the operations user(s) 230 perform substantially similar functions with respect to the first company 153A.

Referring to FIG. 1, the operations user(s) 250 (see FIG. 4) input or upload, into the computing system 120, a description of products and/or services provided by the second company 1536 and their associated prices for any products and/or services offered by the second company 1536 to other users 110 of the system 100. The computing system 120 displays such products and/or services to the other users 110 (the entities 150 and/or the individuals 160) of the system 100. The operations user(s) 250 receive requests for these products and/or services and invoice the purchaser (e.g., the first company 153A) after the products and/or services have been provided.

The operations user(s) 250 may manage a customer table or database (e.g., listing students for academic institutions, passengers for airlines, customers for many types of businesses, and the like) within the database 126 (see FIG. 1).

The operations user(s) 250 may receive requests for quotes and enter quote amounts in response to such requests. The operations user(s) 250 may include a procurement team responsible for purchases made by the second company 153B. Thus, the operations user(s) 250 may request or search for quotes from other users.

The operations user(s) 250 may select other users who must confirm the fulfilment of an event (e.g., a transfer of ownership before payment is released). For example, when a property (e.g., a house) is purchased, the transacting parties may select one or more lawyers who release payment using the computing system 120 after ownership is transferred. A user may also select a background verification company to confirm that the asset is owned by the individual selling it. Thus, using the computing system 120, the background verification company may first confirm ownership and the lawyer(s) may confirm the transfer of the ownership before payment is released. After this occurs, the purchaser (or others) may request registration (or recording) of the purchase with relevant governmental authorities using the computing system 120.

The operations user(s) 250 may offer delivery service options. Thus, users may shop, make instant payments, and request delivery of the purchased items (e.g., property, food, etc.) using the computing system 120.

The operations user(s) 250 may include security personnel. Such operations user(s) may view recently purchased items (e.g., recorded in the database 126 by the computing system 120) when checking purchases (e.g., at exit points). Thus, there is no need to print receipts because the users have electronic receipts displayable on the computing devices 162 (e.g., mobile phones). The security personnel may view these electronic receipts on the computing devices 162 or on their company mobile devices (e.g., tablets).

### Finance User(S)

Referring to FIG. 4, the finance user(s) 232 and 252 generally allocate funds to other company departments and users (e.g., operations, HR, and administrative users), approve quotes selected by these users, and approve payments before the funds are released by the banks 133A and 133B, respectively. For the sake of brevity, the functions performed by the finance user(s) 252 are described below. However, the finance user(s) 232 perform substantially similar functions with respect to the first company 153A.

The finance user(s) 252 may deposit funds directly into the second bank 133B and/or request (short or long-term) loans from the second bank 133B. Before investing funds with the second bank 133B, the finance user(s) 252 may determine whether other branches of the second company 153B require any funds.

The finance user(s) 252 may also perform an auditor review function. By way of non-limiting example, the finance user(s) 252 may access an auditor function (e.g., using a tab labeled “Auditors tab”). From this tab, the finance user(s) 252 may assign viewing rights to one or more auditors. These rights allow the auditor(s) to view information associated with the second company account 226 and/or the company account 170B. The finance user(s) 252 may add an email address for each auditor to which the computing system 120 may send login information (e.g., a password). The auditor(s) may use the login information to log into the computing system 120, view information, and generate reports with respect to the company account 226 and/or the company account 170B.

The finance user(s) 252 may also input an email address for a manager of the auditor(s). The manager may receive a log of activities (e.g., when the auditor(s) were logged on, what the auditor(s) viewed, reports generated by the auditor(s), etc.) performed by the auditor(s) for a period of time (e.g., every month). For government departments, the manager may be the Auditors General and the like.

### Administrative User(S)

The administrative user(s) 234 and 254 are responsible for administrative activities (e.g., airline bookings requests) of the first and second companies 153A and 153B, respectively. For the sake of brevity, the functions performed by the administrative user(s) 254 are described below. However, the administrative user(s) 234 perform substantially similar functions with respect to the first company 153A.

By way of a non-limiting example, the administrative user(s) 254 may receive requests from employees (e.g., one of the users 250-256) for airline bookings, hotel bookings, courier services, and visa applications. The administrative user(s) 254 may search for prices related to these requests. The administrative user(s) 254 may select a particular booking and submit it to the finance user(s) 252 for approval thereby.

The administrative user(s) 234 and 254 may each perform portions of a method 900 illustrated in FIG. 12 and described below.

### HR User(S)

Referring to FIG. 4, the HR user(s) 236 and 256 are responsible for adding individuals as employees (e.g., the employees 240 illustrated in FIG. 5) of the companies 153A and 153B, respectively. This process adds a record for each employee in the database 126 (see FIG. 1) and associates the employee with his/her employer. For the sake of brevity, the functions performed by the HR user(s) 236 are described below. However, the HR user(s) 256 perform substantially similar functions with respect to the second company 153B.

The HR user(s) 236 may pay employees' salaries (as approved by the operations and finance users 230 and 232). The HR user(s) 236 may manage an employee's leave days and pay the employee for such leave days (after approved by the finance user(s) 232). The HR user(s) 236 may maintain a leave table or database within the database 126 (see FIG. 1) that records, for each of the employees 240, days of leave available in a year, days of leave taken, and the balance of days available.

The HR user(s) 236 may confirm an employee's employment status and the employee's salary (or income) in response to requests received via the computing system 120 from other users. For example, when an employee applies for a visa, the visa agency (also a user of the computing system 120) may send a confirmation request (via the computing system 120) to the HR user(s) 236 requesting confirmation of employment status and income. Such confirmation requests may be sent by any user of the computing system 120. The HR user(s) 236 may receive requests for employment certificates for former employees from a background verification company.

### Employees

Referring to FIG. 5, the HR user(s) 236 connect (or associate) the first company account 222 with the employees 240. The employees 240 are listed in the database 126 as employees of the first company 153A and may request products and/or services using the first company account 222. For example, the employees 240 may request airplane tickets for business trips, submit applications for business visas, and the like. Additionally, the employees 240 may submit claims using the computing system 120. The first company 153A may pay salaries and make other payments to the employees 240 via the computing system 120. Thus, after the HR user(s) 236 have added the individual IND2 as one of the employees 240 (see FIG. 5), the individual IND2 may use the computing system 120 to receive a salary and submit claims.

By way of an example, referring to FIG. 4, the individual IND2 (see FIG. 1) may be one of the employees 240 (see FIG. 5) of the first company 153A (see FIG. 1). Each of the employees 240 has two accounts, a personal account (e.g., the second individual account 228) and an employee company account (e.g., an employee company account 268). The personal account may be used to make personal purchases and the employee company account may be used to perform company duties and request reimbursement for business expenses. By way of non-limiting examples, the individual IND2 may submit requests for business visa applications, airplane tickets, hotel bookings for business trips, and courier services through the employee company account 268.

The employees 240 (see FIG. 5) may be divided into various departments based on their job functions. The employees 240 have the option to log on to either their personal account (e.g., the second individual account 228) or the employee company account (e.g., an employee company account 268) using the same email and password. When the individual IND2 logs in the second individual account 228, the individual IND2 may access the funds in the second individual account 228, search quotes, and pay for personal expenses.

### Visa Agency Example

One or more of the entities 150 (see FIG. 1) may be a governmental visa agency. For example, the second company 153B may be a governmental visa agency and the computing system 120 may at least partially implement a visa application process. The operation user(s) 250 may enter (into the computing system 120) a description of types of visas available and their associated prices using block 510 of the method 500 illustrated in FIG. 8.

Applicants (e.g., the individual IND1) may request a visa by viewing the descriptions (block 515) and entering an application (block 520) for the desired visa. When one of the individuals 160 (e.g., the individual IND1) applies for a visa, the individual IND1 uploads documents and may input the user IDs of other users 110 as references for direct confirmation.

The operation user(s) 250 receive the application for a visa from the individual IND1 (in block 525 of the method 500). The operation user(s) 250 may verify and screen applicants. The operation user(s) 250 may receive appointments for biometrics via the computing system 120. The second company 153B may receive (via the computing system 120) bank statements directly from one of the banks 132 used by the individual IND1, employment status from an employer of the individual IND1, and verification of income direct from the HR users of the employer of the individual IND1. By way of another example, the second company 153B may confirm (via the computing system 120) the assets of the individual IND1 known by other users 110 (e.g., local government bodies, deeds offices, and the like). Thus, the computing system 120 may eliminate the need for the individual IND1 to have bank statements stamped by the bank 133A for submission during the visa application process.

The operation user(s) 250 accepts the application for the visa in block 525. When a country requires that an individual guarantee a certain amount of funds before a visa will be issued, in block 530, the computing system 120 instructs the first bank 133A to freeze such funds as part of the visa application process. Then, in block 535, the applicant is notified of the acceptance of the application and/or freezing of the funds. At least a portion of the method 400 may also be performed during the visa application process. For example, the computing system 120 may instruct the first bank 133A to unfreeze the funds (in block 725 of the method 400) at the prescribed time (e.g. upon leaving the country).

### Academic Institution Example

One or more of the entities 150 (see FIG. 1) may be an academic institution. For example, the first company 153A may be academic institution and the operation user(s) 230 may enter (into the computing system 120) descriptions of programs offered by the institution and fees for each program using block 510 of the method 500 illustrated in FIG. 8. Those of the users 110 wishing to participate in one of the programs may view the descriptions (block 515) and indicate a desire to participate or enter an application (block 520). In optional block 525, the operation user(s) 230 may receive the applications (through the computing system 120) and participate in selection of applicants.

The first company 153A may use the descriptions provided by a governmental visa agency (e.g., the second company 153B) to quote the fees for student visas to international students. After obtaining consent from a student, the second company 153B may obtain information (e.g., student offer letters) directly from the academic institution (e.g., the first company 153A) via the computing system 120.

Other users 110 may receive direct confirmation via the computing system 120 from the academic institution regarding the student.

As mentioned above, the individuals 160 may apply to the academic institution via the computing system 120. The academic institution may retain all applications submitted via the computing system 120 and criteria used for selection. When applying, students may enter a user ID of a guardian or sponsor. Students may connect with the academic institution in the same way that the companies connect with employees.

One of the users 110 (e.g., guardian or sponsor) may use the user ID associated with a student user (and a student number) and the user ID associated with the academic institution to pay fees and other costs for the student user at the academic institution.

The operation user(s) 230 may receive requests for academic confirmations for present or former students from third parties (e.g., background verification entities, described below). In response to such requests, the operation user(s) 230 may send academic confirmations to the third parties after consent is obtained from the present or former student. The operation user(s) 230 may post results (e.g., grades, test results, and the like) for students via the computing system 120 if such students wish to receive these results via the computing system 120. The students may also grant permission to other users (e.g., guardians, sponsors, and the like) to view the results.

### Airline Example

One or more of the entities 150 (see FIG. 1) may be an airline. For example, the first company 153A may be an airline. The operations user(s) 230 may list flights and their associated airfares using block 510 of the method 500 illustrated in FIG. 8. The operation user(s) 230 may also manage flight bookings. The operation user(s) 230 may upload a list of people considered to be dangerous (e.g., a no-fly list) and these people can be prevented from booking a flight. This list can also be shared with other partners (e.g., other users 110 who are also airlines). The operation user(s) 230 may upload a list of meals and other items sold by the airlines.

Using information entered by the operation user(s) 230, the individuals 160 may use the computing system 120 to do one or more of the following:
1. Book flights;
2. Select meals, seats, luggage being checked or carried on, etc.;
3. Pay luggage fees;
4. Select other individuals (one or more of the users 110, such as family, hotels, and friends) to receive updates via the computing system 120 regarding flight information (e.g., check-in information, departure information, landing information, delay information, etc.);
5. Shop for inflight products before (e.g., days before) the flight; and
6. Read inflight magazines before the flight.

When one of the users 110 (e.g., the individual IND2) shops for and purchases one or more inflight products before the flight, the prices of the product(s) is frozen and released only when the individual IND2 checks-in. The individual IND2 may receive the product(s) onboard the flight.

### Supermarket Example

One or more of the entities 150 (see FIG. 1) may be a supermarket. For example, the first company 153A may be a supermarket. The operation user(s) 230 may list descriptions of products and their associated prices using block 510 of the method 500 illustrated in FIG. 8. Customers (e.g., the individual IND2) may order groceries by viewing the descriptions (block 515) and indicating a desire to purchase one or more of the groceries (block 520). In optional block 525, the operation user(s) 230 may receive and accept the purchase. The operation user(s) 230 may also bill customers. Then, in block 530, the computing system 120 instructs the bank 133B used by the individual IND2 to transfer the funds from the second individual account 172B to the first company account 170A. Finally, in block 535, the individual IND2 may be notified of the purchase and/or fund transfer.

### Mobile Network Service Provider Example

Referring to FIG. 1, one or more of the entities 150 (see FIG. 1) may be a mobile network service provider. For example, the first company 153A may be a mobile network service provider. The individuals 160 (which include the operation user(s) 230) may travel using a visa (received via the computing system 120) and air tickets (booked via the computing system 120).

Additionally, the individuals 160 may use the computing system 120 to apply for a subscriber identification module (“SIM”) card before departure. The individuals 160 may use the computing system 120 to search for service providers located at the destination airport and apply for the SIM card before leaving the country. The individuals 160 may specify the size of the SIM card (e.g., nano, micro sim, etc.). The cost of the SIM card (or the SIM charge) may be debited (by the computing system 120) immediately upon request and the individual may receive a mobile number in advance that can be shared with other users. The individual may buy data packages using the computing system 120 in advance of the flight and the computing system 120 may debit any costs for the data packages when the individual checks in. Upon arriving at the airport, the individual may produce a passport and collect the SIM card. Individuals may also pay bills and buy services from mobile service providers using the computing system 120.

### Healthcare Facility Example

One or more of the entities 150 (see FIG. 1) may be a healthcare facility (e.g., a hospital). For example, the first company 153A may be a healthcare facility. The operation user(s) 230 may enter or upload descriptions of services (medical checks, vaccines, etc.) offered at the hospital using block 510 of the method 500 illustrated in FIG. 8. The users 110 may schedule an appointment by viewing the descriptions (block 515) and indicating a desire for an appointment (block 520). The entities 150 may schedule appointments (medical checks and vaccines before employment) for their employees using the computing system 120. The individuals 160 may schedule appointments for personal consultations using the computing system 120.

By way of an example, the individual IND2 may indicate a desire for an appointment. In block 530, the computing system 120 instructs the second bank 133B used by the individual IND2 to freeze sufficient funds in the second individual account 172B to cover the cost of the appointment. In block 535, the individual IND2 may be notified of the appointment and/or freezing of the funds.

At least a portion of the method 400 illustrated in FIG. 7 may also be performed. For example, the computing system 120 may instruct the second bank 133B to unfreeze the funds (in block 425 of the method 400) after the appointment has been completed. Then, the computing system 120 transfers the unfrozen amount to the first company account 170A of the first company 153A.

Doctors may use the computing system 120 to view their appointment schedules and confirm attendance of patient. Once confirmation is completed, doctors may use the computing system 120 to select tests to be performed. The individual IND2 may view the tests and their total cost. The individual IND2 may use the computing system 120 to search for other cheaper healthcare facilities or medical centers for the tests to be conducted. When tests are completed, the individual IND2 is notified via the computing system 120.

The healthcare facility may be connected to medical insurance companies via the computing system 120 allowing individuals (or patients) to search for healthcare facilities or medical centers that accepts their medical insurance. For example, a user may enter the user ID assigned by the computing system 120 to the user's medical insurance company and search for healthcare facilities or medical centers that accept the relevant medical insurance. When the individual IND2 schedules an appointment, the operations users 230 of the first company 153A may view the medical coverage of the individual IND2 and the maximum amount(s) covered. Thus, when the operations user(s) 230 bill the individual IND2, the operations user(s) 230 bill only an amount that will be covered by the insurance company. The amount billed and the services provided are confirmed online by the individual IND2. Therefore, claims forms are not necessary and need not be completed (e.g., manually) by either the individual IND1 or the first company 153A. Also, the individual IND2 has access to a soft copy of all the receipts using the second individual account 228.

### Government Agency (or Department) Example

One or more of the entities 150 (see FIG. 1) may be a government agency or department. For example, the first company 153A may be a government agency or department. The operation user(s) 230 may list descriptions of services and/or products (e.g., licenses, fines, permits etc.) and their associated prices using block 510 of the method 500 illustrated in FIG. 8. The individuals 160 (e.g., the individual IND1) may view (block 515) and indicate a desire to purchase one or more of these services and/or products (block 520). The individual IND1 may also submit requirements or reference another user (e.g. bank) which will give direct confirmation to the first company 153A. In optional block 525, the operation user(s) 230 may receive and accept the purchase. Then, in block 530, the computing system 120 instructs the bank 133A used by the individual IND1 to transfer the funds from the first individual account 172A to the first company account 170A. Finally, in block 535, the individual IND1 may be notified of the purchase and/or fund transfer.

The operation user(s) 230 may upload a list of persons of interests (e.g., wanted criminals, people on bail, and the like). The persons of interests may be prevented from booking tickets on a flight (even though the individual IND1 has the right to make such a reservation).

### Local Government Authority Example

One or more of the entities 150 (see FIG. 1) may be a local governmental authority or utility. For example, the first company 153A may be a local governmental authority or utility. The operation user(s) 230 may enter bills or invoices that are sent to one of the users 110 (e.g., the individual IND2) in block 610 of the method 600 illustrated in FIG. 9. In block 615, the individual IND2 reviews and approves the invoice for payment. Then, in block 620, the invoice amount is transferred from the second individual account 172B to the first company account 170A. Lastly, the first company 153A and/or the individual IND2 may be notified of the transfer.

The individual IND2 may pay the invoice anywhere in the world instantly using the user ID of the first company 153A and an account number (e.g., assigned by an electrical utility to the individual). For example, an individual in Singapore may pay the electricity bill instantly on his behalf or on behalf of someone else in the USA.

By way of another non-limiting example, individuals may pay parking fees using the computing system 120 without paying a parking meter. Referring to FIG. 8, the operation user(s) 230 (see FIG. 4) may list parking locations and their associated parking fees using block 510 of the method 500. The individual IND2 may search for a desired parking location (e.g., by viewing the descriptions in block 515) and may indicate a desire to rent the desired parking location (block 520). The individual IND2 may also identify a vehicle that will be parked in the desired parking location or the computing system 120 may already have the vehicle information. Then, in block 530, the computing system 120 instructs the bank 133B used by the individual IND2 to transfer the funds from the second individual account 172B to the first company account 170A. Finally, in block 535, the individual IND2 may be notified of the purchase and/or fund transfer.

FIG. 10 is a flow diagram of a method 700. In first block 710, the parking fee is received by the first company account 170A for a selected parking location from the individual IND2. After block 530 of the method 500, the first company 153A has received the parking fee. Thus, block 710 is satisfied.

In next block 715, the software 124 (executed by the computing system 120) updates the database 126. The database 126 stores a list of vehicles (e.g., cars) for which parking fees have been paid at that particular time.

In block 720, a parking enforcement officer enters an identifier (e.g., a license plate number) of a particular vehicle into the computing system 120 and the software 124 queries the database 126 for the identifier.

In decision block 725, the computing system 120 determines whether the parking fees have been paid for the vehicle. The database 126 may indicate the parking fees have been paid for the vehicle if the vehicle appears in the database 126. The decision in decision block 725 is “YES,” when the computing system 120 determines the parking fees have been paid for the vehicle. Otherwise, the decision in decision block 725 is “NO.”

When decision in decision block 725 is “YES,” the method 700 terminates. Otherwise, in block 730, the parking enforcement officer issues a parking ticket. Then, the method 700 terminates.

Thus, as explained above, the individual IND2 may pay parking fees without paying a parking meter, printing a receipt, or displaying the receipt on the vehicle (e.g., on the dashboard or in a window).

### Hotel Example

One or more of the entities 150 (see FIG. 1) may be a hotel. For example, the first company 153A may be a hotel. The operation user(s) 230 enter or upload room, meal, drink, and/or other prices (block 510 of the method 500 illustrated in FIG. 8) and these prices are viewable by other users (block 515). The individual IND2 may book a hotel room (block 520) and (in block 530) the cost of the room is frozen in the second individual account 172B. The individuals 160 may view their selected rooms and the view from that room prior to booking the room.

At least a portion of the method 400 illustrated in FIG. 7 may also be performed. For example, the computing system 120 may instruct the first bank 133A to unfreeze the funds (in block 425 of the method 400) as the costs are incurred (e.g., the room charge may be released each day as the guest stays at the hotel). Other costs (such as food, laundry, etc.) may be charged as incurred and the first company 153A may use block 610 of the method 600 to bill the individual IND2. The individual IND2 receives notification of the charge and the individual IND2 confirms payment (block 615) on their computing device 163B (e.g., through a pin code). The individuals 160 may automatically receive air miles (if the hotel is partners with the individual airlines or others) as the individuals 160 pay for any costs incurred during the stay at the hotel.

The operation user(s) 230 may receive (via the computing system 120) notifications of flight details and status information with respect to hotel guests if the guests desire (e.g., those guests that require airport pick-up by the hotel). The operation user(s) 230 may schedule staff according to their work or duties (e.g., housekeeping, laundry, etc.) using the computing system 120.

### Bank Example

One or more of the entities 150 (see FIG. 1) may be a bank. For example, the first company 153A may be a bank. The operation user(s) 230 may enter (into the computing system 120) descriptions of product(s) and/or service(s) (e.g., loans and investments options) available to the users 110. The operation user(s) 230 may receive requests for confirmations and send confirmations via the computing system 120. With the consent of the individuals, the operation user(s) 230 may perform asset and liability searches nationally or internationally using the computing system 120. The operation user(s) 230 may offer hedging services. The operation user(s) 230 may review applications (e.g., for loans) submitted. The operation user(s) 230 may enter or upload exchange rates used by the computing system 120.

### Recruiting Example

Referring to FIG. 6, the HR user(s) 236 (see FIG. 4) may use the method 300 when recruiting personnel. For example, when the first company 153A (see FIG. 1) needs to recruit staff, in blocks 310 and 315, the HR user(s) 236 may issue a request for quote to recruitment agencies and appoint a recruitment agency in blocks 330-345. When the recruitment agencies are entering quotes (in blocks 320 and 325), they may quote a fixed amount or include a retention fee. A retention fee will be a fee paid by the first company 153A if the recruit stays with the first company 153A for an agreed period of time.

In block 350, both the retention fee (if applicable) and the fixed quote amount are frozen by the first bank 133A after the quote has been selected. When the first company 153A selects a quote (in block 330-345) with a retention fee clause, the retention fee is held by the bank 133A during the specified retention period. During this period, the retention fee earns a specified interest rate for the recruitment agency. The fixed quote amount is released and paid (block 425 of the method 400 illustrated in FIG. 7) after the first company 153A, the recruitment agency, and the job candidate confirm (via the computing system 120) that a job candidate has signed a contract of employment.

The recruitment agencies may search for job candidates on the computing system 120. Those of the users 110 may list themselves on the computing system 120 (as searchable and) seeking employment. Academic institutions that are users of the computing system 120 may post a list of recent graduates that is viewable by the recruitment agencies. This list may show only a student number, qualifications, and graduation date. However, only recruitment agencies with appointed quotes may search for job candidates and allowed to view contact details of the candidates.

Each of the recruitment agencies may contact only a predetermined number of candidates for each quote for which the recruitment agency has been appointed.

Once the recruitment agency identifies a job candidate, the recruitment agency may schedule an interview (using the computing system 120) between the candidate and the HR user(s) 236 of the first company 153A. The HR manager may use the computing system 120 to invite other relevant managers to join the interviews and these invitees may select one of the candidates. Records of the interviews and feedback entered by invitees is available on the company user account 222. The HR user(s) 236 (and/or other users) may confirm attendance at interviews and the selection of a job candidate (referred to as the “selected candidate”). The selected candidate may not list themselves on the computing system 120 (as searchable and) seeking employment for at least a predetermined period of time (e.g., six months).

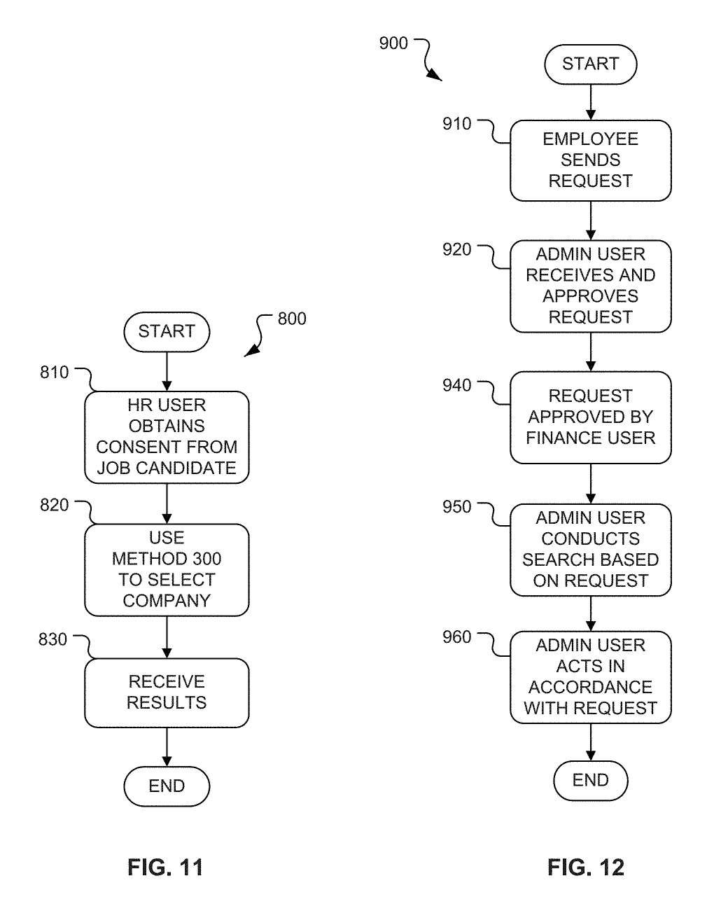

Once the candidate is selected, the HR user(s) 236 may perform Background Verification (BV) checks using a method 800 illustrated in FIG. 11. In first block 810, the HR user(s) 236 obtains consent from the candidate for the BV checks via the computing system 120. Next, in block 820, the HR user(s) 236 uses the method 300 to select a BV company to perform the BV checks.

At this point, the BV company can start performing the BV checks on the candidate using the computing system 120. For example, the BV company can send communications including requests for background information to other users. Such users may include law enforcement (and the communication may request criminal records), one or more previous employers (and the communication may request confirmation of employment), one or more academic institutions (and the communication may request confirmation of academic qualifications), and the like.

In block 830, the HR user(s) 236 receive the results of the BV checks via the computing system 120. The results may be a simple pass or fail indication.

After the candidate is selected, the HR user(s) 236 may use the method 800 illustrated in FIG. 11 to select a medical center to perform medical checks and/or schedule for vaccines. The first company 153A may only conduct medical checks permitted by the laws of the relevant country.

In first block 810, the HR user(s) 236 obtains consent from the candidate for the medical checks and/or vaccines via the computing system 120. Next, in block 820, the HR user(s) 236 uses the method 300 to select a healthcare provider to perform the medical checks and/or administer the vaccines.

At this point, the job candidate schedules an appointment for the medical check and/or administration of the vaccines. The HR user(s) 236 may schedule employees (e.g., pilots) that require regular medical checks.

In block 830, the HR user(s) 236 receive the results of the medical checks and/or confirmation of the administration of the vaccines via the computing system 120. The results may be a simple pass or fail indication.

The computing system 120 may record one or more of the following pieces of information and associates this information with the relevant account(s) on the computing system 120:
1. Identities (e.g., user IDs) of job candidates interviewed;
2. Users selected using quote process(es) for each stage (appointment of recruitment agencies, BV companies, healthcare facilities, etc.);
3. Results of BV checks;
4. Medical tests performed and/or results of those tests; and
5. Details related to acceptance of contract.

### Employee Request Example

As mentioned above, the employees 240 (see FIG. 5) may submit requests using the computing system 120. For example, the employees 240 may submit business visa applications, requests for airplane tickets, requests for hotel bookings for business trips, and requests for courier services.

FIG. 12 is a flow diagram of a method 900 that may be used to process employee requests. For ease of illustration, the method 900 will be described with respect to the individual IND2, who, in this example, is one of the employees 240 of the first company 153A.

In first block 910, the individual IND2 submits a request on the computing system 120 using the employee company account 268.

In next block 920, the administrative user(s) 234 (see FIG. 4) review and approves the request on the computing system 120. The computing system 120 sends this approval to the finance user(s) 232 (see FIG. 4).

In next block 940, the finance user(s) 232 (see FIG. 4) review and approves the request on the computing system 120.

In next block 950, the administrative user(s) 234 (see FIG. 4) conducts a search on the computing system 120 based on the request. For example, the administrative user(s) 234 may search for airfares, hotel rooms, etc.

In next block 960, the administrative user(s) 234 (see FIG. 4) acts in accordance with the request. For example, the administrative user(s) 234 may book a flight, a hotel room, and the like. By way of another non-limiting example, the administrative user(s) 234 may apply for a visa, hire a courier service, and the like.

### Laws and Regulations Example

Referring to FIG. 1, various government ministries (e.g., those associated with the sub-organization accounts 290A-290C illustrated in FIG. 13) may list laws and regulations (in the computing system 120) according to different industries and sectors over which the ministries have jurisdiction. This list may be viewed by the user 110 (e.g., the companies 153A and 153B) as applicable. The following are examples of the types of information that a ministry or department may list:

a. a ministry of health may list medical checks required for employment and/or visas, which may be linked to a medical center section.

b. an immigration ministry may post types of visas, which may be be linked with the visa section.

c. a ministry of labor may post minimum wage, minimum working hours, maximum working hours, standard contract for certain employees (e.g., helpers), which may be viewable by applicable companies.

d. ministries may post licenses required by companies. When companies obtain these licenses, they will be able to view the registration dates and expiry dates from all of the government departments. The computing system 120 may also display costs related to the licenses (e.g., cost of renewing the licenses). The computing system 120 may also send reminders when the expiry date approaches.

### Compliance Certificate Example

The computing system 120 may help confirm compliance with the laws and regulations. For example, the computing system 120 may record or store compliance certificates. The follow process may be used by the computing system 120 to obtain a compliance certificate. For ease of illustration, the process will be described as being performed by the first company 153A. A head of a legal department (e.g., a general counsel) of the first company 153A allocates compliance with laws and/or regulations to relevant users (e.g., one or more of the operations, finance, administrative, and HR users 230-236). The relevant users confirm compliance (by entering confirmations into the computing system 120). Then, the board of directors (described below) of the first company 153A may enter final confirmations into the computing system 120. Thus, using this process, a two level compliance certificate is obtained by the computing system 120.

### Blocking Purchases Example

The users 110 may set their accounts to block certain purchases for certain reasons (e.g., users belonging to a certain religion can block pork, beef, or alcoholic items). Purchases may also be blocked for health reasons. For example, a user who is allergic to nuts may set the user's account to not purchase anything that includes nuts.

### Board of Directors Example

Referring to FIG. 4, the finance users 232 and 252 may set up Boards of Directors for the companies 153A and 153B. For example, the computing system 120 may display a tab for this purpose. For example, the finance user(s) 232 may use the tab to request that one of the individuals 160 (see FIG. 1) join the board of directors of the first company 153A. This request may be confirmed by the operations user(s) 230, the administrative user(s) 234, and HR user(s) 236 before the individual is added into the board of directors. Typically, users to be included in the board of directors include a legal secretary of the first company 153A and other relevant users who attend board meetings. After the meetings, the minutes may be entered into the computing system 120 and shared with the board members on the computing system 120. The members can comment on the minutes and the sender can edit them. Once agreed upon, the members may confirm the minutes as final using the computing system 120. These minutes may only be shared by a chairperson of the board. The computing system 120 may also maintain a track register that shows a list of users with which the minutes have been shared.

### Wills Example

The users 110 may write and file wills (using the computing system 120 and, optionally, lawyers) with the relevant government department. The individuals 160 may draft wills that lawyers may confirm using the computing system 120. Assets listed in a will as being owned by an individual (e.g., the individual IND4) may be listed or stored on the computing system 120. When there is a change in ownership of an asset or anything happens, the heir or beneficiary may send a notification using the computing system 120 to the individual (e.g., the individual IND4) and/or the lawyer representing the individual. The notification may indicate that the will needs to be updated because of the change in ownership that occurred. By way of another non-limiting example, the computing system 120 may send a notification to a beneficiary when the beneficiary reaches a predetermined age if the beneficiary is set (according to a will stored on the computing system 120) to inherit a certain asset if the beneficiary is below the predetermined age.

Depending upon the implementation details, the computing system 120 (including the software 124 and, optionally, the database 126) may provide one or more of the following advantages over the prior art.

The computing system 120 may provide a convenient way of making instant payments anywhere in the world using only a unique user ID. Thus, there is no need for bankcards, swift codes, or inputting other information (e.g., an account number, the name of the individual, etc.). This convenience is further enhanced by the funds being available via banks (e.g., accessible at automated teller machines (“ATMs”), online, or at the banks) as cash.

The computing system 120 may be used to provide direct confirmations to the users 110. For example, the users 110 may obtain direct confirmation (e.g., documents) from relevant parties. Further, the computing system 120 may be used to obtain consent (if necessary) from relevant parties. For example, the computing system 120 may be used (e.g., by visa agencies or BV companies) to obtain bank statements directly from a bank or confirmation of academic qualifications directly from a university. By way of another non-limiting example, the computing system 120 may be used (e.g., by BV companies) to request a criminal records search of a candidate (individual user) directly by a police agency. By way of another non-limiting example, the computing system 120 may be used (e.g., by banks) to search a user's assets and/or liabilities to assess worthiness. By way of another non-limiting example, the computing system 120 may be used (e.g., by banks) to search deeds to confirm ownership of a property or asset before the property or asset is purchased.

The computing system 120 may be used by healthcare facilities (e.g., hospitals) to invoice insurance companies.

The users 110 may use the computing system 120 to apply for SIM cards in advance of traveling and/or to select other users (e.g., relatives and friends) to receive flight information and/or status. The users 110 may use the computing system 120 to search for items from nearby supermarkets, compare prices, make purchases, and have items delivered to their homes. The users 110 may use the computing system 120 to pay parking fees (e.g., using their mobile devices). A first user may use the user ID of a different second user to make a purchase anywhere in the world as long as the second user confirms the purchase on one of the computing devices 162 (e.g., a mobile device) wherever the second user is located.

The computing system 120 may provide improved transparently. For example, the user 110 may seek quotes from other users in a transparent manner. The quotes received may be viewable by all or a relevant portion of the users 110 at the same time thus no one will be able to tamper with the quotes. These functions are available to governmental organizations (e.g., with government accounts like the main government account 280 or the sub-organization accounts 290A-290C illustrated in FIG. 13). Referring to FIG. 1, the computing system 120 retains records of decisions (e.g., selection of quotes) making this information available for future reference, which enhances transparency. The auditor function helps improve transparency, accountability, and reduces corruption.

The computing system 120 may help reduce costs. For example, because the users 110 may seek quotes in a transparent manner, they will be able to reduce their costs. Transfer or transaction costs may be reduced (saving the users 110 money) because the users 110 are grouped together (by the computing system 120) making business transactions between different users simpler and/or easier.

The computing system 120 may help reduce the number of documents printed because most transactions (and related documents) will be available online via the computing system 120. The users 110 may share documents via the computing system 120 with any other user (e.g., companies). For example, a visa or permit agency may obtain documents directly online via the computing system 120 from another user (e.g., one of the banks 132). Thus, there is no need to obtain a bank statement stamped by the bank, which must be first printed and then stamped. This saves both paper and time. By way of another non-limiting example, medical centers do not need to print and complete documents (e.g., medical receipts, claim forms, etc.) to submit claims to medical insurance companies. By way of yet another non-limiting example, as explained above, receipts for parking fees do not need to be printed and placed on vehicles (e.g., on dashboards).

The computing system 120 may reduce dependence on physical currently or notes and coins, which helps protect the environment.

The computing system 120 guarantees payment after delivery of products or services. One of the challenges of offering products or services to international customers or unknown local customers is the uncertainty of receiving payment after the products or services have been delivery. Because the computing system 120 guarantees payment for all quotes entered and selected using the method 300 illustrated in FIG. 6, this uncertainty is no longer a challenge. Thus, markets may be expanded beyond borders, which may result in better quality products, cheaper products, and/or increased profits for suppliers.

Referring to FIG. 1, the computing system 120 implements a BV process that may be better and more thorough because a BV company may (after obtaining the individual's consent) search criminal records locally and/or globally. Due diligence with respect to companies may be easier and/or less costly because direct confirmations may be obtained using the computing system 120. Persons of interest lists can be shared by concerned and/or relevant users of the computing system 120. For example, airlines and/or government agencies may share a list of individuals considered to be dangerous (e.g., the no-fly list). Thus, the computing system 120 may help protect people by providing better security controls.

### Payment Process

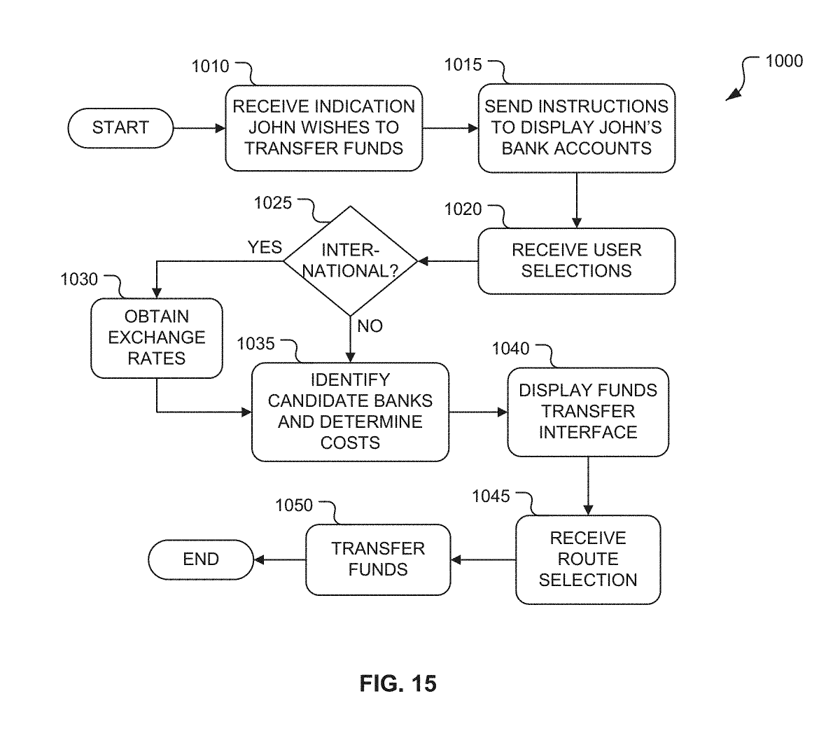

FIG. 15 is a flow diagram of a payment process 1000 performed by the computing system 120. The payment process 1000 may be used to transfer funds for any purpose (e.g., to make a purchase). The payment process 1000 is configured to implement local and international payments at the lowest cost to the users 110.

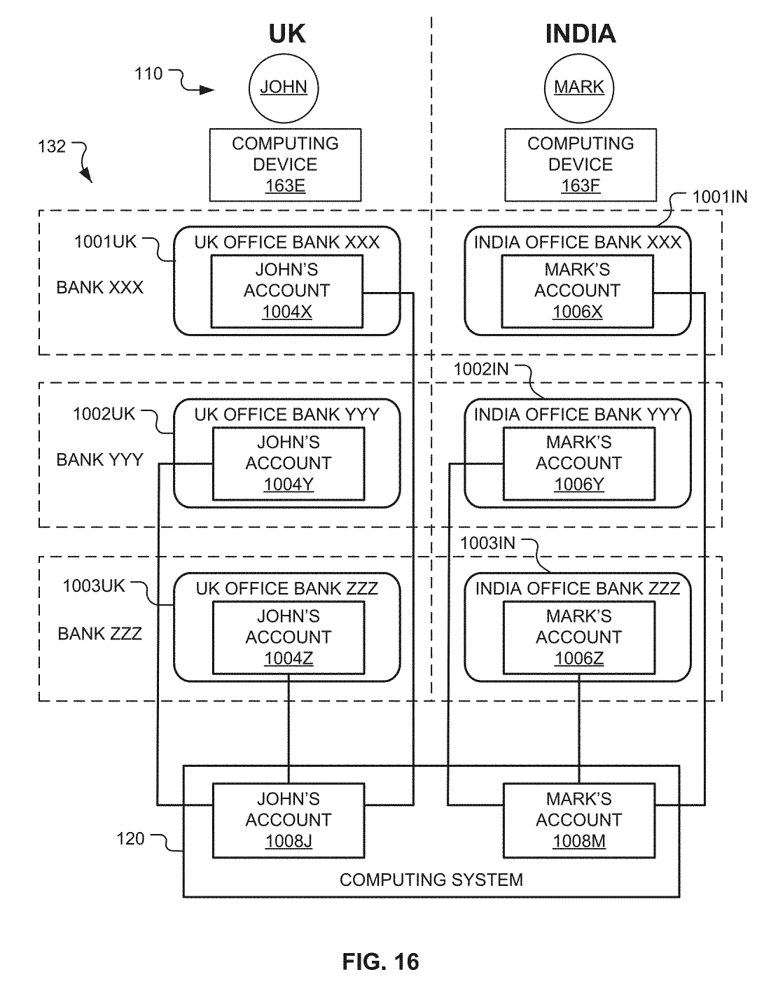

Referring to FIG. 1, as mentioned above, the users 110 are account holders at the banks 132. For ease of illustration, referring to FIG. 16, the users 110 will be described as including John and Mark and the banks 132 will be described as including Banks XXX, YYY, and ZZZ. John and Mark operate computing devices 163E and 163F, respectively, that are substantially similar to the computing devices 162 (see FIG. 1) and connected to the computing system 120 (e.g., via the network 180 illustrated in FIG. 1). Each of the computing devices 163E and 163F may be implemented as the computing device 12 (see FIG. 14) described below.

The Banks XXX, YYY, and ZZZ are each international banks and have offices 1001UK-1003UK, respectively, in the United Kingdom (“UK”) and offices 1001IN-1003IN, respectively, in India. John has accounts 1004X-1004Z in the UK at the Banks XXX, YYY, and ZZZ, respectively, and Mark has accounts 1006X-1006Z in India at the Banks XXX, YYY, and ZZZ, respectively. Within the computing system 120, each of the users 110 has a single user account under which one or more bank accounts are stored or linked. For example, referring to FIG. 16, John has a user account 1008J (created by the software 124 illustrated in FIG. 1) linked to his accounts 1004X-1004Z at Banks XXX, YYY, and ZZZ and Mark has a user account 1008M (created by the software 124 illustrated in FIG. 1) linked to his accounts 1006X-1006Z at Banks XXX, YYY, and ZZZ.

The payment process 1000 (see FIG. 15) will be described with respect to the following example. John wishes to transfer 500 Indian Rupees (“R”) from one of his accounts 1004X-1004Z in the UK to Mark in India. John's money in his accounts 1004X-1004Z is denominated in British Pounds (“£”). In the example, John has £50 in his account at Bank XXX, £21 in his account at Bank YYY, and £23 in his account at Bank ZZZ. Mark's money in his accounts 1006X-1006Z is denominated in the Indian Rupees.

Referring to FIG. 15, in first block 1010, the computing system 120 receives an indication from one of the users 110 (e.g., John) that the user would like to transfer funds to another one of the users 110 (e.g., Mark).

In block 1015, the computing system 120 sends instructions to the computing device 163E to display an input for the recipient (Mark) of the funds being transferred and an input for an amount being transferred. The computing system 120 may also instruct the computing device 163E to display a list of selectable payment options. By way of a non-limiting example, after the recipient Mark has been identified, the computing system 120 may determine in which countries Mark has accounts. Because Mark has accounts in only India and John has account only in the UK, the computing system 120 may automatically determine that an international funds transfer is needed. In other words, whenever the sender and recipient do have any accounts in the same country, the computing system 120 may automatically determine that the funds transfer is international.

On the other hand, whenever the sender and recipient each have an account in the same country, the computing system 120 may instruct the computing device 163E to display a list of selectable payment options that include (1) a local (or domestic) funds transfer and (2) an international funds transfer. For each of these payment options, the follow sub-options may be available: (a) transfer funds within the same bank or (b) transfer funds between different banks. Alternatively, the John may select how the transfer is implemented based on transaction costs (discussed below). For the international funds transfer option, an input for the recipient country may also be displayed if the recipient has accounts in more than one country. By way of a non-limiting example, after the recipient has been identified, the computing system 120 may instruct the computing device 163E to display a list of countries in which the recipient has accounts. If the recipient has accounts in only one country, that country may be selected automatically.

In block 1020, the computing system 120 receives a user selection that identifies Mark as the recipient and the amount being transferred as 500 Indian Rupees. The computing system 120 determines automatically that the transfer is international. Because Mark has accounts in only India, John need not identify India as the recipient country. However, for other recipients, in block 1020, the computing system 120 may receive an indication of whether the transfer is local or international, and, when the recipient has accounts in more than one country, an identification of the recipient country.

In decision block 1025, the computing system 120 determines whether the user (John) indicated the transfer is local or international. If the transfer is international, the computing system 120 advances to block 1030. On the other hand, if the transfer is local, the computing system 120 advances to block 1035.

In block 1030, the computing system 120 obtains exchange rates from the relevant banks (e.g., the Banks XXX, YYY, and ZZZ). Since international funds transfers involve difference currencies, different banks may use different exchange rates for the buying and selling of the currencies involved. For example, Table A below provides example exchange rates for the Banks XXX, YYY, and ZZZ. These rates are applicable to all branches in all countries. Then, the computing system 120 advances to block 1035.

TABLE A
Exchange Rates Uploaded at the Bank's Head Offices and
Applicable to All of Their Branches Globally

| | | (What the Bank Client | (What the Bank Client |
|---|---|---|---|
| | | Pays for $1 USD) | Receives for $1 USD) |
| | Currency | Buying Rate - $1 USD | Selling Rate - $1 USD |
| Bank | British | £0.65 | £0.50 |
| XXX | Pound | | |
| | Indian | R 12 | R 10 |
| | Rupee | | |
| Bank | British | £0.60 | £0.55 |
| YYY | Pound | | |
| | Indian | R 11.5 | R 11 |
| | Rupee | | |
| Bank | British | £0.75 | £0.60 |
| ZZZ | Pound | | |
| | Indian | R 13 | R 12 |
| | Rupee | | |

By way of a non-limiting example, the Banks XXX, YYY, and ZZZ may upload exchange rates (e.g., from their head office accounts) to the computing system 120. For example, the exemplary exchange rates shown in Table A (above) might be uploaded to the computing system 120.

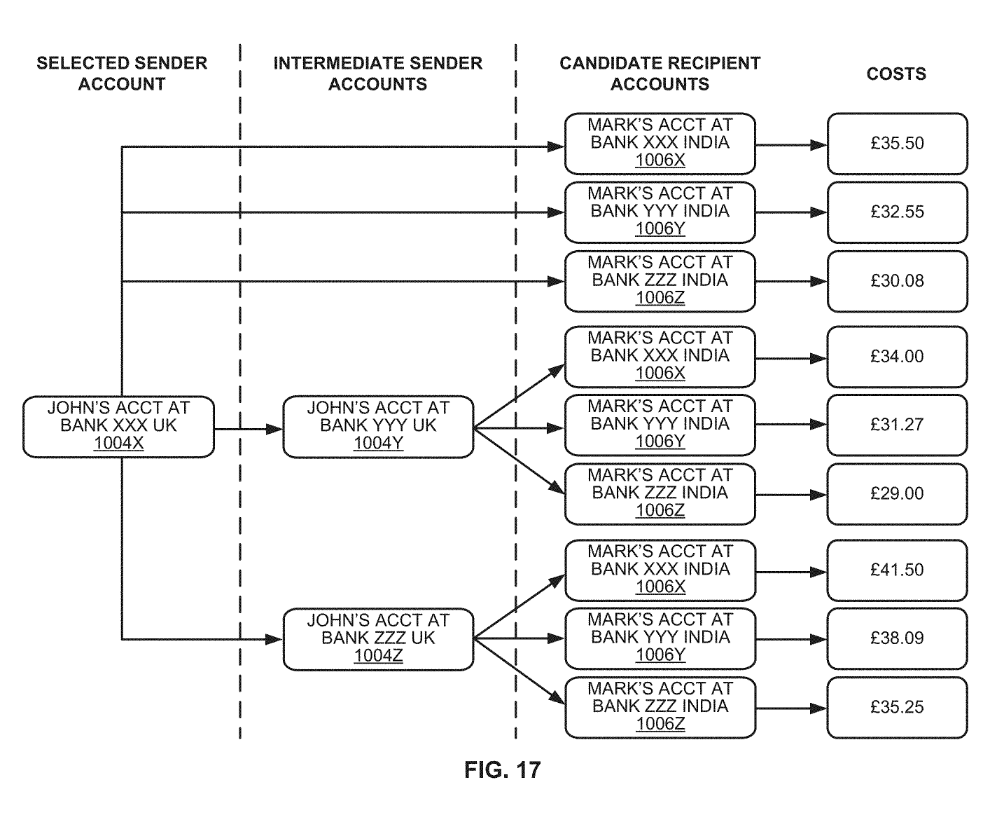

In block 1035, the computing system 120 identifies a set of candidate sender banks, identifies a set of candidate receiver banks, and determines costs (e.g., service fees and costs associated with exchange rates) associated with transferring the funds from accounts at the candidate sender banks (e.g., John's account 1004X at the Bank XXX), directly or via one of the candidate sender banks, to each candidate receiver bank. In this example, only John's account 1004X has sufficient funds to transfer 500 Rupees to Mark. Therefore, the computing system 120 need only determine costs for transferring the funds from John's account 1004X, directly or via John's accounts 1004Y and 1004Z, to each of Mark's accounts 1006X-1006Z. In other words, the computing system 120 determines costs for each route of sending funds from John's account 1004X to each of Mark's accounts 1006X-1006Z. Thus, in the example, the Banks XXX, YYY, and ZZZ are both the candidate sender banks and the candidate receiver banks. FIG. 17 illustrates all of the possible routes by which funds might be sent from John's account 1004X at the Bank XXX to Mark's accounts 1006X-1006Z and the costs incurred by each route. As shown in FIG. 17, funds may be transferred from John's account 1004X at the Bank XXX to one of John's accounts 1004Y and 1004X at either the Bank YYY or ZZZ, respectively, before being sent to one of Mark's accounts 1006X-1006Z.

The computing system 120 may charge different service fees depending upon how the transaction is implemented. For example, the service fees for transactions within the same bank may typically be less expensive than service fees for transactions between different banks. Additionally, since international funds transfers involve difference currencies, different banks may use different exchange rates for the buying and selling of the currencies involved. Thus, the users 110 (see FIGS. 1 and 16) may incur two different charges: (1) the service charge, and (2) the difference between the buying and the selling rates.

Table B below shows exemplary values for international transfers within the same bank. As mentioned above, Mark is to receive 500 Rupees from John. Referring to the first row of Table B, for the Bank XXX, the exchange rate for Rupees to USD is 10 Rupees for one USD. Thus, 500 Rupees would purchase $50 USD (i.e., 500/10=$50), which is shown in the third column below. For the Bank XXX, the exchange rate for USD to British Pounds is £0.65 for one USD (or £0.65/USD). Thus, the $50 USD would purchase £32.50 British Pounds (i.e., $50*0.65=£32.5), which is shown in the fourth column below.

As mentioned above, an international transfer service fee (which may be a percentage or fixed amount) is charged. In this example, a fixed amount of £3 is used. Thus, the total costs for the direct transfer from John's account 1004X to Mark's account 1006X would be £35.50 (i.e., £32.50+£3=£35.50), which is shown in the ninth column below.

As mentioned above, when the account has an insufficient balance for the transfer, a local transfer service fee (which may be a percentage or fixed amount) may be charged for transferring funds to cover the shortfall. Because the transfer of 500 Rupees from John's account 1004X to Mark's account 1006X would cost £35.50 and John has £50 in his account 1004X, the local transfer service fee does not apply. However, a fixed amount of £1 is charged by the Banks YYY and ZZZ (see the second and third rows of the Table B) for obtaining funds from the Bank XXX.

TABLE B

| | | USD | British Pounds | | | Available | | |
|---|---|---|---|---|---|---|---|---|
| | | needed to Buy | needed to buy | Int'l | Total | Balance | Local Transfer | |
| John's | Mark's | 500 Rupees at | USD at Bank's | Transfer | Cost For | in John's | Service Fee if | Total |
| UK | India | Bank's Rupee | Pound Buying | Service | Direct Int'l | Bank | insufficient | Cost For |
| Account | Account | Selling Rate ($) | Rate (£) | Fee (£) | Transfer (£) | Account (£) | funds (£) | Transfer (£) |
| Bank | Bank | 50.00 | 32.50 | 3.00 | 35.50 | 50.00 | N/A - | 35.50 |
| XXX | XXX | | | | | | Sufficient | |
| | | | | | | | Funds | |
| Bank | Bank | 45.45 | 27.27 | 3.00 | 30.27 | 21.00 | 1.00 | 31.27 |
| YYY | YYY | | | | | | | |
| Bank | Bank | 41.67 | 31.25 | 3.00 | 34.25 | 23.00 | 1.00 | 35.25 |
| ZZZ | ZZZ | | | | | | | |

Table C shows exemplary values for international transfers between two different banks. Again, Mark is to receive 500 Rupees from John. The first row of Table C shows a transfer from the John's account 1004X to Mark's account 1006Y. The exchange rate of the Bank YYY for Rupees to USD is 11 Rupees for one USD. Thus, 500 Rupees would purchase $45.45 USD (i.e., 500/11=$45.45), which is shown in the third column of the first row below. For the Bank XXX, the exchange rate for USD to British Pounds is £0.65 for one USD (or £0.65/USD). Thus, the $45.45 USD would purchase £29.55 British Pounds (i.e., $45.45*0.65=£29.55), which is shown in the fourth column of the first row below. Similarly, referring to the second row of Table C, for the transfer from John's account 1004X to Mark's account 1006Z, the cost shown in the fourth column is £27.08 (i.e., 500/12*0.65=£27.08).

An international transfer service fee (which may be a percentage or fixed amount) is charged. In this example, a fixed amount of £3 is used. Thus, referring to the first row of Table C, the total costs for the transfer from John's account 1004X to Mark's account 1006Y would be £32.55 (i.e., £29.55+£3=£32.55), which is shown in the ninth column below. Similarly, referring to the second row of Table C, the total costs for the transfer from John's account 1004X to Mark's account 1006Z would be £30.08 (i.e., £27.08+£3=£30.08), which is shown in the ninth column below

Again, when the account has an insufficient balance for the transfer, a local transfer service fee (which may be a percentage or fixed amount) may be charged. Because the transfer of 500 Rupees from John's account 1004X to either Mark's account 1006Y or 1006Z would cost less than £50, the local transfer service fee does not apply. However, a fixed amount of £1 is charged for transfers from John's accounts 1004Y or 1004Z (see the bottom four rows of the Table C) for obtaining funds from John's account 1004X at the Bank XXX. For example, a shortfall amount (e.g., £28−£21+£1=£8) is transferred from John's account 1004X to John's account 1004Y before the international transfer is made from John's account 1004Y to Mark's account 1006Z.

TABLE C

| | | USD | British Pounds | | | Available | | |
|---|---|---|---|---|---|---|---|---|
| | | needed to Buy | needed to buy | Int'l | Total | Balance | Local Transfer | |
| John's | Mark's | 500 Rupees at | USD at Bank's | Transfer | Cost For | in John's | Service Fee if | Total |
| UK | India | Bank's Rupee | Pound Buying | Service | Direct Int'l | Bank | insufficient | Cost For |
| Account | Account | Selling Rate ($) | Rate (£) | Fee (£) | Transfer (£) | Account (£) | funds (£) | Transfer (£) |
| Bank | Bank | 45.45 | 29.55 | 3.00 | 32.55 | 50.00 | N/A - | 32.55 |
| XXX | YYY | | | | | | Sufficient | |
| | | | | | | | Funds | |
| Bank | Bank | 41.67 | 27.08 | 3.00 | 30.08 | 50.00 | N/A - | 30.08 |
| XXX | ZZZ | | | | | | Sufficient | |
| | | | | | | | Funds | |
| Bank | Bank | 50.00 | 30.00 | 3.00 | 33.00 | 21.00 | 1.00 | 34.00 |
| YYY | XXX | | | | | | | |
| Bank | Bank | 41.67 | 25.00 | 3.00 | 28.00 | 21.00 | 1.00 | 29.00 |
| YYY | ZZZ | | | | | | | |
| Bank | Bank | 50.00 | 37.50 | 3.00 | 40.50 | 23.00 | 1.00 | 41.50 |
| ZZZ | XXX | | | | | | | |
| Bank | Bank | 45.45 | 34.09 | 3.00 | 37.09 | 23.00 | 1.00 | 38.09 |
| ZZZ | YYY | | | | | | | |

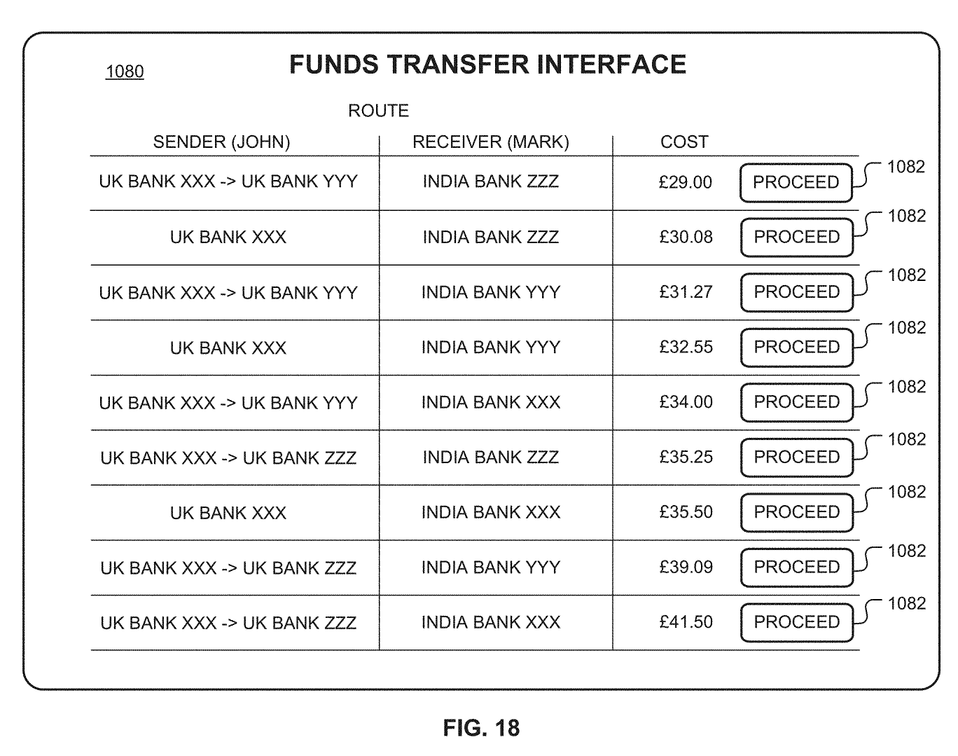

In block 1040, the computing system 120 instructs the computing device 163E to display a funds transfer interface 1080 (see FIG. 18) that includes each route, its associated costs, and a proceed button 1082 next to each route. In the example illustrated in FIG. 18, the routes are sorted in ascending order by cost so that the least expensive route is displayed first. Thus, the rows are sorted from least expensive to most expensive.

The funds transfer interface 1080 lists the costs for all possible transfers from John's account 1004X (identified as “UK BANK XXX” in FIG. 18) to Mark. For example, the first row of the funds transfer interface 1080 shows a transfer from John's account 1004X to Marks's account 1006Z (identified as “INDIA BANK ZZZ” in FIG. 18) via John's account 1004Y (identified as “UK BANK YYY” in FIG. 18). The second row show costs associated with a direct transfer from John's account 1004X to Marks's account 1006Z without an intermediate bank.

The user selects a particular route by selecting (e.g., clicking) on the proceed button 1082 next to the particular route. The transfers (first local and/or international) of the selected route are performed automatically (e.g., with one click) by the computing system 120.

Generally speaking, for international funds transfers, the costs will be different among different banks and the cheapest route will typically be the route from the bank with the lowest buying rate (third column in Table A above) to the bank with the highest selling rate (fourth column in Table A above). The computing system 120 gives the user (e.g., John) the option to transfer funds to the bank with the highest selling rate as compared to the other recipient banks thus making the transfer as cheap as possible. Also, if the user has insufficient enough funds in the bank with the lowest buying rate, the computing system 120 display routes (and associated costs) in which the user transfers funds into this bank locally (and possibly incur a local transfer service fee) from another bank before the international transfer occurs.

On the other hand, when the user (e.g., John) is making a local funds transfer, the funds transfer interface 1080 shows only the transfer service fees. It is generally cheaper to transfer funds between accounts within the same bank locally so this will typically be displayed in the first row.

In block 1045, the computing system 120 receives a selected route by which to transfer the funds. In this example, John selected the (cheapest) route shown in the first row of the funds transfer interface 1080.

Finally, in block 1050, the computing system 120 transfers the funds using the selected route received in block 1045. Optionally, a verification process may be performed in block 1050. Movement of the funds in accordance with the selected route may be done automatically (optionally after the applicable verification process). The transfers (first local and/or international) of the selected route are performed automatically (e.g., with one click) by the computing system 120. Thus, if the user (e.g., John) selected an international funds transfer or payment, the transfer is instant.

### Payment Method

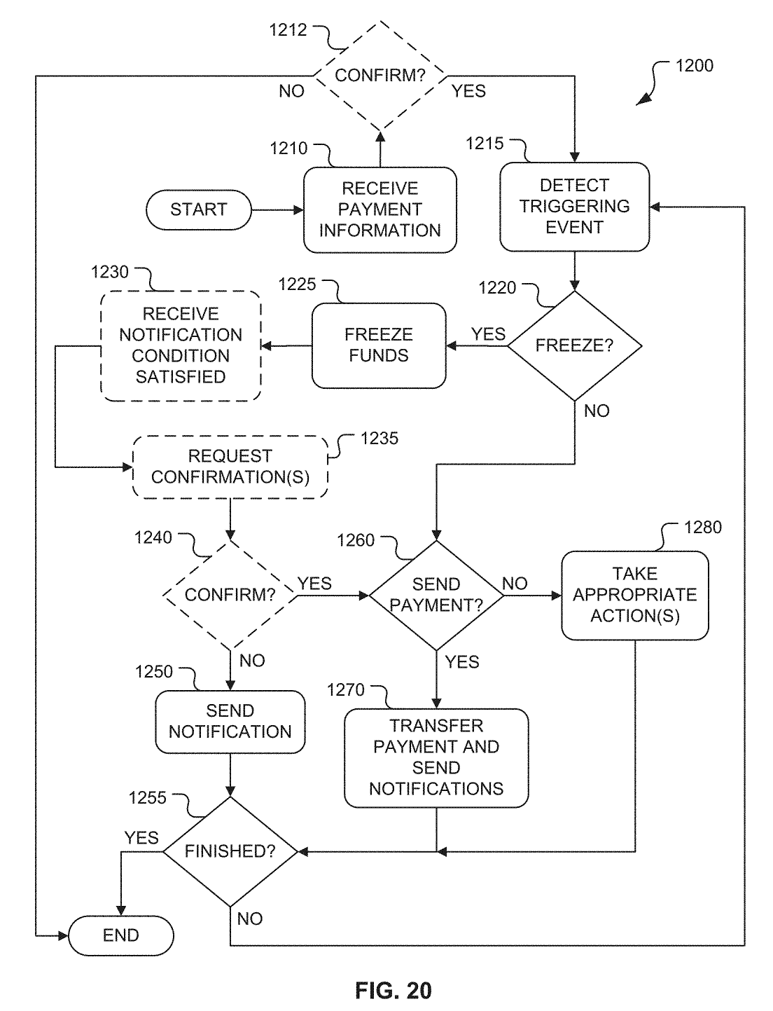

FIG. 20 is a flow diagram of a method 1200 that may be performed by the computing system 120 when it transfers funds from a first user to a second user. In first block 1210, the first and/or second user input payment information into the computing system 120. Thus, in block 1210, the computing system 120 receives the payment information. The payment information may include payment conditions, product information, milestones, and the like. The computing system 120 monitors transactions and messages to detect when a payment condition has been triggered.

Then, in optional decision block 1212, the computing system 120 decides whether the payment information has been confirmed. For example, if the second user entered the payment information, the first user may be required to confirm the payment information. If the payment information has been confirmed, the computing system 120 advances to block 1215. Otherwise, the method 1200 terminates. If the optional decision block 1212 is omitted, the computing system 120 advances from block 1210 to block 1215.

In block 1215, the computing system 120 detects a payment triggering event. For example, the second user may input into the computing system 120 that all or part of a contract has been completed. Alternatively, the computing system 120 may automatically detect a transaction has occurred that triggers payment.

In decision block 1220, the computing system 120 decides whether to freeze funds in accordance with the payment conditions received in block 1210.

If the computing system 120 decides to freeze funds, in block 1225, the computing system 120 freezes a payment amount. Optionally, the computing system 120 may calculate the payment amount in block 1225. In optional block 1230, the computing system 120 receives a notification from the second user (or another approved user) that a payment condition has been satisfied. In optional block 1235, the computing system 120 sends a request to confirm that the condition has been satisfied. The request may be sent to the first user or another party.

In optional decision block 1240, the computing system 120 decides whether satisfaction of the condition has been confirmed. If the condition has not been confirmed, the computing system 120 advances to block 1250. Otherwise, the computing system 120 advances to decision block 1260. In embodiments in which block 1230-1240 are omitted, the computing system 120 advances directly to block 1260 after block 1225.

In block 1250, the computing system 120 sends a notification to the second user. Optionally, a dispute resolution process may be initiated. Then, in decision block 1255, the computing system 120 decides whether the method 1200 is finished (e.g., there are no additional triggering events identified in the payment conditions). If the method 1200 is finished, the method 1200 terminates. Otherwise, when the method 1200 is not finished, the computing system 120 returns to block 1215 to detect another triggering event.

If the computing system 120 decided not to freeze funds in decision block 1220, the computing system 120 advances to decision block 1260. In decision block 1260, the computing system 120 decides whether to send the payment from the first user to the second user. For example, the computing system 120 may require a confirmation (e.g., from the first user) before transferring payment to the second user.

If the computing system 120 decides to send the payment, in block 1270, the computing system 120 transfers the payment from the first user to the second user and may optionally notify the second user that the payment has been sent. Optionally, in block 1270, if necessary, the computing system 120 may calculate the payment amount before transferring the payment. Then, the computing system 120 advances to decision block 1255.

If the computing system 120 decided not to send the payment in decision block 1260, in block 1280, the computing system 120 takes one or more appropriate actions (e.g., notifies the second user). Then, the computing system 120 advances to decision block 1255.

### Taxation

Referring to FIG. 1, the companies 153A and 153B may register their trade licenses with the computing system 120. The government entity 153C may confirm, using the computing system 120, compliance by the companies 153A and 153B with local requirements. The computing system 120 may display the license expiration dates and other details.

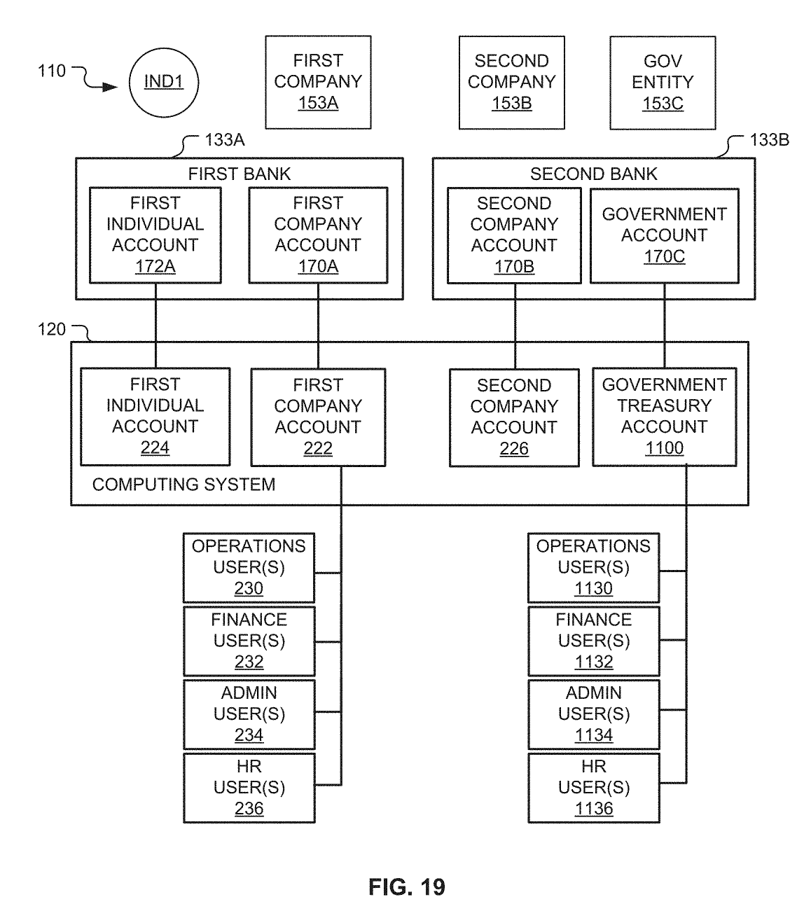

Referring to FIG. 19, the government entity 153C has a government treasury account 1100 on the computing system 120 linked to the government account 170C at the second bank 133B. For illustrated purposes, the government entity 153C (e.g., a treasury) has tax levying and/or tax enforcement authority with respect to the individual IND1 and the first company user 153A. FIG. 19 also includes the first individual account 172A and the first company account 170A both at the first bank 133A. As explained above, the first company account 222 may be accessed by the operations user(s) 230, the finance user(s) 232, the administrative user(s) 234, and the HR user(s) 236. Similarly, the government treasury account 1100 may be accessed by operations user(s) 1130, the finance user(s) 1132, the administrative user(s) 1134, and the HR user(s) 1136. Each of the users 1130-1136 is registered with the computing system 120 as explained above.

The operations user(s) 1130 may set up taxes (e.g., sales tax, income tax, value-added tax (“VAT”), and any other tax) owed by one or more of the users 110 (e.g., the companies 153A and 153B). Different tax rates may be specified for different industries. Sales tax rates may be for that particular country in which the government entity 153C has jurisdiction. These taxes are owed to the government account 170C represented in the computing system 120 by the government treasury account 1100. The government entity 153C may also specify an import duty for certain industries and/or products. These rates are applicable to relevant ones of the users 110.

### Sales Taxes

The computing system 120 may be used to automatically charge sales tax and credit the tax amount charged to the government treasury account 1100 (which may be forwarded thereby to the government account 170C). In block 1210 (see FIG. 20), one of the operations user(s) 230 of the company 153A adds products and services offered by the first company 153A to the computing system 120. As mentioned above, the operations user(s) 1130 may enter sales tax rates and rules into the computing system 120. These products and services are automatically subjected to the sales tax set by the operations user(s) 1130 under the government treasury account 1100. On the other hand, if a product is not subject to sales tax or the first company 153A falls under an industry exempted from sales tax, the first company 153A will exclude the sale tax. However, before this exemption is effected, it is confirmed online by the operations user(s) 1130 of the government entity 153C.

The computing system 120 automatically detects (block 1215 of FIG. 20) when payment of a transaction is made. In block 1270 (see FIG. 20), the percentage of the sale tax is automatically deducted and paid directly to the government treasury account 1100 (which may forward the funds to the government account 170C). The amount deducted is instantly available to the government entity 153C for spending as soon as the sales transaction is completed. In block 1270 (see FIG. 20), the government entity 153C receives a record of the tax payment that identifies the amount paid, the first company 153A, an invoice number, and a receipt number.

Sometimes, in block 1225, funds may be held (until delivery). When this occurs, the sales tax is automatically deducted and paid to the government treasury account 1100 (which may forward the funds to the government account 170C) when delivery is confirmed (decision block 1240 of FIG. 20) by both parties and the frozen funds are released (block 1270 of FIG. 20).

By way of non-limiting example, the finance user(s) 232 and 1132 may access a tab labeled “Tax tab” displayed by the computing system 120. The sales tax per transaction is displayed under the Tax tab to the finance user(s) 232 and 1132. The Tax tab may also display the record of the tax payment (identifying the amount paid, the first company 153A, the invoice number, and the receipt number).

### Individual Income Taxes

The computing system 120 may be used to pay and collect individual income taxes. In block 1210 (see FIG. 20), the one or more of the operations user(s) 1130 may set-up individual tax brackets and associated applicable tax rates (e.g., for $0-$10 000->5%; 10 001-20 000->10%; etc.). These rates will be applicable to employee salaries (e.g., as employer withholdings).

By way of non-limiting example, in block 1210 (see FIG. 20), the HR user(s) 236 and 1136 may access a tab labeled “Salary tab” displayed by the computing system 120. The Salary tab displays a list of all employees and the HR user(s) 236 uploads or adds the gross salaries of the employees. Using the rates uploaded by the operations user(s) 1130, each individual's taxes are calculated.

Paying the individuals is a triggering event detected in block 1215 (see FIG. 20). In block 1270, when the HR user(s) 236 pays the employees (after approval from finance user(s) 232), the income taxes (e.g., employer withholdings) are automatically paid by the employer to the government treasury account 1100 (and may be forwarded thereby to the government account 170C).

For example, if the individual IND1 is an employee of the first company 153A, in block 1210 (see FIG. 20), the HR user(s) 236 uploads or adds the gross salary of the individual IND1 to the computing system 120 (e.g., using the Tax tab). Then, the computing system 120 determines a payroll withholding amount for the individual IND1 using the tax rates uploaded by the operations user(s) 1130. In block 1215 (see FIG. 20), the computing system 120 detects when the HR user(s) 236 of the first company 153A pays the individual IND1. Turning to FIG. 20, the decision in decision block 1220 is “NO,” and the decision in decision block 1260 is “YES.” Returning to FIG. 19, in block 1270 (see FIG. 20), the payroll withholding amount is automatically paid by the employer to the government treasury account 1100 (and may be forwarded thereby to the government account 170C).

### Company Income Taxes

The computing system 120 may be used to pay and collect company income tax. The government entity 153C estimates company profit as a percentage of sales. Estimated company profit is the amount on which income tax may be owed. However, company income tax is not paid automatically. Instead, the estimated company profit is used only for other estimates. One of these other estimates is based on revenue versus expenses and is determined on a real-time basis.

### Property Gains Taxes

The computing system 120 may be used to pay and collect property gains tax. As mentioned above, the companies 153A and 153B may be registered with the computing system 120 and confirmed by the government entity 153C. Thus, the government entity 153C is aware of property and its owner(s). Such properties and its owners may be shown or listed under the government entity 153C.

Companies and individuals may use the computing system 120 to sell one or more of the properties listed on the computing system 120. For example, in block 1210 (see FIG. 20), owners can list their assets (land, houses, cars, etc.) as for sale on the computing system 120. Whenever a user purchases an asset, in block 1210 (see FIG. 20), the user provides to the computing system 120 proof of payment for the asset (e.g., an agreement of sale, proof of payment, and the like), an identification of the bank from which payment was made, and an identification of the bank to which the payment was made. In decision block 1212 (see FIG. 20), the bank(s) (from which the payment was made and received) confirm the transaction with the computing system 120. If attorneys are involved, the attorneys will also confirm the transaction with the computing system 120 in decision block 1212 (see FIG. 20). The transaction amount is listed by the computing system 120 as the buying price. When the new owner sells this property, the computing system 120 detects the payment triggering event in block 1215 (see FIG. 20). Both the profit on the sale of the property and the tax on this profit are calculated by the computing system 120 in block 1270 (see FIG. 20). The computing system 120 may include an option to calculate the tax based on the real profit after taking into account inflation over the number of ownership years. In block 1270 (see FIG. 20), the computing system 120 pays the taxes automatically to the government treasury account 1100 (which may be forwarded thereby to the government account 170C) as soon as the transfer of ownership takes place.

### Import Taxes

The computing system 120 may be used to pay and collect import tax. In block 1210 (see FIG. 20), the operations user(s) 1130 select applicable products, industries, sectors, and the like, and input tax rates and rules into the computing system 120. Whenever, one of the users 110 uses the computing system 120 to buy an item subject to an import tax, the computing system 120 detects the payment triggering event in block 1215 (see FIG. 20). In block 1270, the computing system 120 adds the applicable import tax to the product cost and automatically pays the tax to the government treasury account 1100 (which may be forwarded thereby to the government account 170C).

### Vat

The computing system 120 may also be used to pay and collect VAT. The operations user(s) 230 may input an application into the computing system 120 seeking to add the first company 153A as a VAT company. This request is sent by the computing system 120 to the operations user(s) 1130. Once the operations user(s) 1130 approve the first company 153A, the first company 153A is registered with the computing system 120 as a VAT company and can charge VAT for approved products.

The computing system 120 may display a NET VAT tab to the finance user(s) 232 of the first company 153A, which is a VAT vendor. The finance user(s) 232 may use the NET VAT tab to compare the total VAT charged by the first company 153A to the total VAT charged to the first company 153A by others registered VAT companies. For example, the NET VAT tab may display a net VAT amount that indicates an amount payable to or owed by the first company 153A. The computing system 120 may provide the net VAT amount to the first company 153A at any time on a real time basis.

### Other Taxes

The computing system 120 may also be used to collect and pay other taxes. For example, the computing system 120 may be used to collect and pay airport taxes. In block 1210 (see FIG. 20), the government entity 153C (e.g., main treasury) may set an airport tax amount for an individual for either an airport arrival or an airport departures. Thus, when the individual IND1 books a flight using the computing system 120, the computing system 120 detects the payment triggering event in block 1215 (see FIG. 20). In block 1270 (see FIG. 20), the airport taxes may be paid automatically by the computing system 120 to the government entity 153C for non-cancellable tickets. For other types of tickets, the airport taxes may be transferred to the government entity 153C (in block 1270 of FIG. 20) after the individual IND1 checks in or after cancellation deadline date has passed.

By way of another non-limiting example, the computing system 120 may be used to collect and pay real property taxes. Like with other taxes, in block 1210 (see FIG. 20), the government entity 153C (e.g., state government, county government, etc.) may set real property tax rates. The computing system 120 may automatically calculate real property taxes for those of the users 110 who have listed their real property with the computing system 120. The computing system 120 detects a payment triggering event in block 1215 (see FIG. 20) when the real property is sold. In block 1270 (see FIG. 20), profit from the sale of real property may be determined and automatically paid to the government treasury account 1100 (which may be forwarded thereby to the government account 170C).

### Surplus/Deficit Analysis

The computing system 120 may determine and display a financial status (e.g., deficit or surplus) of the government entity 153C. For example, the computing system 120 may display a tax analysis tab to the operations and finance user(s) 1130 and 1132. The tax analysis tab displays government revenue received (e.g., taxes, fees from government services, etc.) by the government entity 153C and government expenditures made (or financial obligations owed) by the government entity 153C.

The government revenue displayed by the tax analysis tab may include one or more of the following:
1. Sales taxes paid directly to the government treasury account 1100 in real time when a sales transaction takes place.
2. Individual income taxes, even though the actual tax amount is paid on a periodic (e.g., monthly or weekly) basis. For the purposes of the analysis, the computing system 120 may calculate total income per hour for each of the individual users and the individual tax rate per hour for each of the individual users based on income per hour.
3. Company income taxes, which may be determined for each company as the lower of the two options. First option, tax be it per hour/weekly or month will be calculated profit from the result of total revenues less total expenses paid at that particular time. The second option will be to estimate the profit using the known industry mark-up on the revenues and from this the income taxes can be tabulated. From the different options of calculating company profit, the lowest will be used to calculate the company income taxes to be used for the analysis.
4. All other government taxes and revenues, including, for example, visa application fees, license fees, etc.

The government expenditures displayed by the tax analysis tab include, for example, costs incurred by the different government departments or ministries of the government entity 153C, and salaries of employees of the government entity 153C.

The tax analysis tab also displays an analysis of government revenue and government expenditures. The analysis includes calculating the net position (surplus/deficit) of the government entity 153C for a particular period of time. The computing system 120 may display the results of this calculation as a status per month, per week, per day, per hour, or even per second. When the analysis is broken down to, for example per hour, fixed costs (like salaries and monthly rentals) are divided by the number of days, hours etc.

### Governance

The computing system 120 may guarantee member contributions to regional and international bodies. Non-limiting examples of regional bodies include the European Union, United Nations (“UN”), Southern African Development Community (“SADC”), Economic Community of West African States (“ECOWAS”), and the like. The members of these regional bodies include countries that joined for various reasons. These bodies require contributions from their member states, usually based on a percentage of, for example, gross domestic product (“GDP”), tax collected, etc. The computing system 120 is able to guarantee these contributions as per the periodicity chosen by the regional body.

For example, after the payment information is received in block 1210 (see FIG. 20), the computing system 120 may detect a triggering event periodically (e.g., each week). For example, the regional body may require a certain percentage of the tax collected by each member state on a weekly basis. In block 1225 (see FIG. 20), the member contributions may be frozen on real time basis and remitted (in block 1270 in FIG. 20) to an organization body account on a weekly basis. Alternatively, a percentage of the GDP of each member state may be used. The GDP of each member state may be calculated (e.g., on a weekly or monthly basis) and the amount of the member contributions frozen (in block 1225 in FIG. 20) and released (in block 1270 in FIG. 20) as per the agreed periodicity (with the body and the member states or any other members).

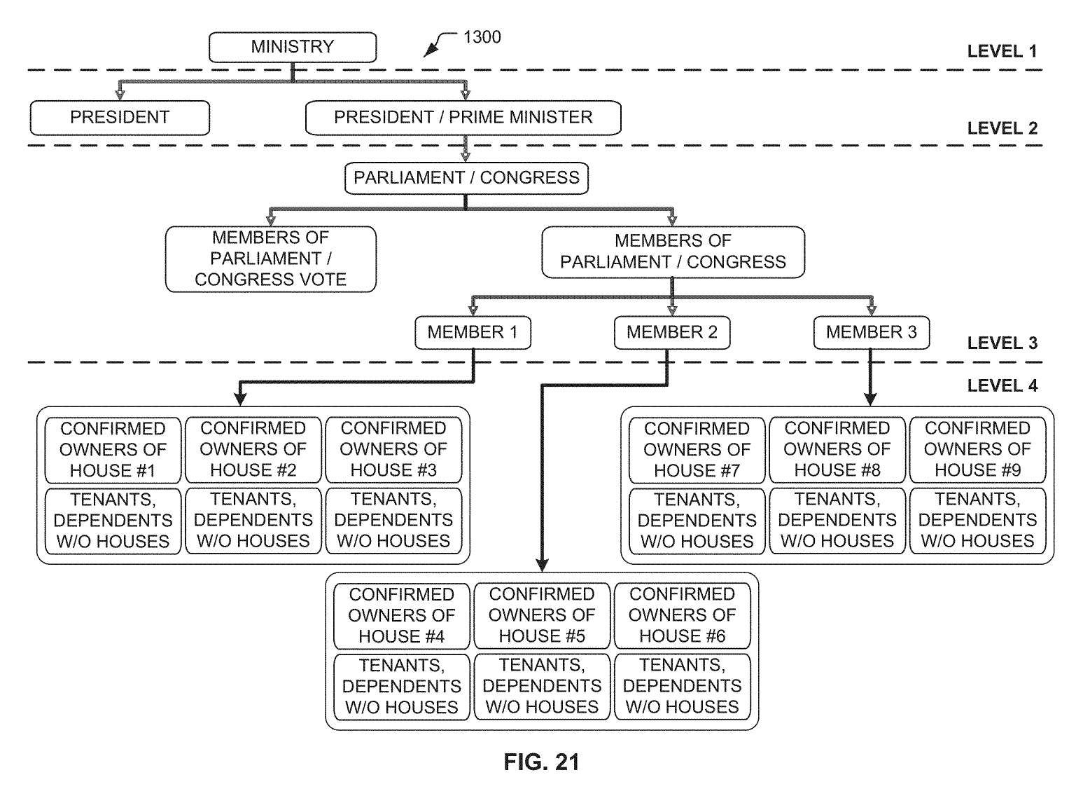

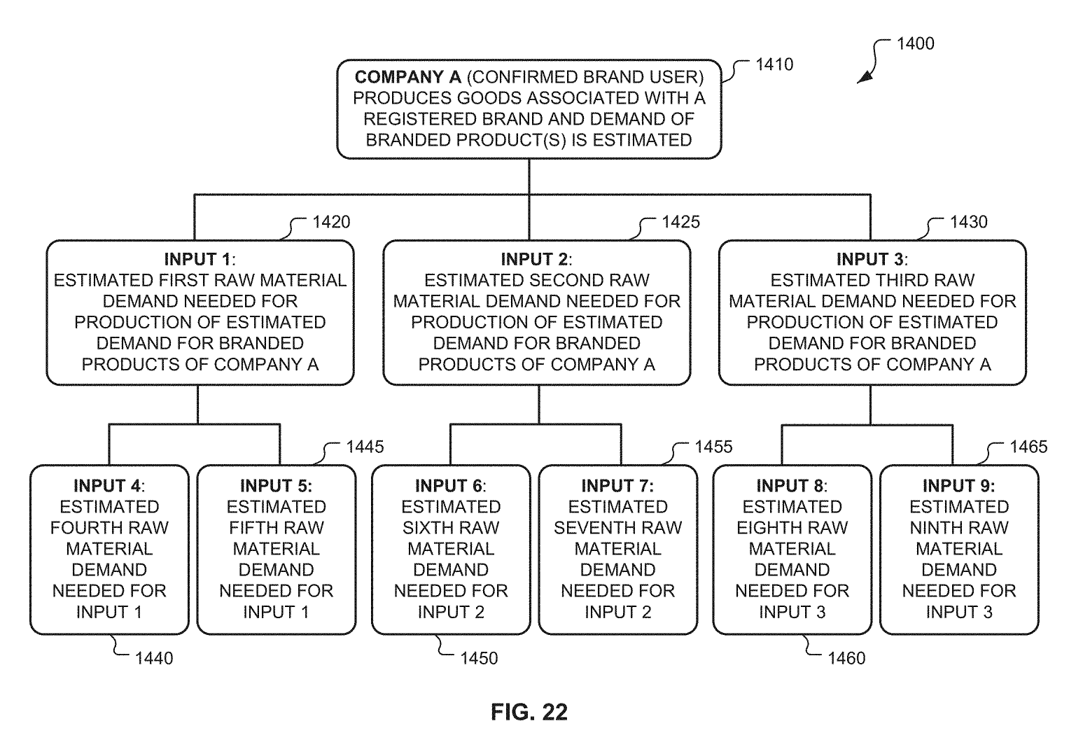

FIG. 21 illustrates an exemplary matrix 1300 for a particular jurisdiction that may be used by the jurisdiction when making decisions. For example, the matrix 1300 may be used to provide confirmations in block 1212 or 1240 (see FIG. 20). The computing system 120 stores a matrix like the matrix 1300 for each country. The matrix for a particular country is based on the laws and/or constitution of that country. The matrix 1300 may be configured for certain transactions. For example, the matrix 1300 may be configured for sale or purchase of military weapons to certain countries, contracts above a certain value, approval exceptions to the current laws, etc. This matrix is set and approved by the relevant different levels as per the law of the country.

In the matrix 1300, level 1 is the government department or ministry level. Level 2 is the prime minister/president level. As required, the matrix 1300 may include levels 3 and 4. At level 3, the members of parliament or congress vote on the computing system 120. However, if an action requires approval of level 4, the action is referred to the population of the country (e.g., for a popular vote). The population is listed under each governor/congress/parliament member depending on their residential address (ownership). For those who do not own houses, the address registered on the computing system 120 will be used to determine under which governor/congress/parliament member they vote. The general populace decision can be used to either determine the vote of each member (in level 3) or the aggregate number of the populace will be used to determine whether the ministry (level 1) should go ahead with the decision as set in the matrix 1300. All participants on all of the levels of the matrix 1300 are registered users with the computing system 120.

The computing system 120 may help ensure good governance over public funds. The government entity 153C and other relevant organizations will be able to set positions or minimum requirements (e.g., minimum salary of certain individuals who are responsible for overseeing or governing public funds) in the computing system 120. For example, in block 1210 (see FIG. 20), the HR user(s) 1136 may identify in the computing system 120 those users who make decisions relating to public funds. This information may be stored in a table or database (e.g., a HR database associated with the government entity 153C and/or other relevant organizations) within the database 126 illustrated in FIG. 1.

Most of these users receive end of service payments (e.g., pensions, gratuity, and other end of service payments) some of which may be related to individual performance. Payment of funds toward these end of service payments to a user may be detected by the computing system 120 as a triggering event in block 1215 (see FIG. 20). A certain percentage or fixed amount of these funds may be set aside or frozen (in block 1225 of FIG. 20) by the computing system 120 during office tenure. This set aside amount may be frozen or otherwise held by the computing system 120. The frozen set aside amount encourages good governance. The computing system 120 may release the frozen set aside amount (in block 1270 of FIG. 20) if release conditions are satisfied (in blocks 1230-1240 of FIG. 20). For example, the release conditions may require that an independent audit be performed. The computing system 120 may require approval by a committee (which will approve release of the frozen set aside amount after the release conditions have been satisfied) at the end of the user's office tenure. Thus, the end of service payments may serve their desired function of encouraging good performance.

The computing system 120 may be used to guarantee payments at agreed upon milestones. When users agree to make payments after completion of certain milestones, the computing system 120 may guarantee such payments before works begins. In block 1210 (see FIG. 20), one or both of the parties provide the following information to the computing system 120: (1) total value of the contract; (2) description of each milestone; (3) percentage completion; and (4) and value of each milestone. This information is agreed upon and confirmed by both users in the computing system 120 (in block 1212 of FIG. 20). After this confirmation, commencement of each milestone may be confirmed by both parties in the computing system 120. The confirmation may be detected as a triggering event in block 1215 (see FIG. 20). After the parties confirm the commencement of a milestone, the computing system 120 freezes (in block 1225 of FIG. 20) the value of the milestone and hence guarantees payment. In block 1270 (see FIG. 20), the value of the milestone is released only after completion of the milestone and confirmation (blocks 1230-1240 of FIG. 20) is received by the computing system 120 from both the users. Optionally, the users may select other independent users (e.g., quality testing firms) to confirm completion of particular milestones with the computing system 120 in blocks 1235 and 1240 (see FIG. 20).

The computing system 120 may be used to guarantee royalties or enforce a royalty agreement. Two or more of the users 110 may enter into an agreement in which a first user owes royalties to a second user. For example, the users 110 may include a football club that owns a trademark, a selected company that produces jerseys, and a stockist that sells jerseys produced by the selected company. The football club may have an agreement with the selected company that allows the selected company to produce and sell football jerseys bearing the trademark owned by the football club. The selected company sells these football jerseys through the stockist. Under the agreement, the football club is entitled to a certain percentage of the revenue (or a royalty amount) from sales of the football jerseys. In block 1210 (see FIG. 20), the football club may specify the certain percentage in the computing system 120. In block 1212 (see FIG. 20), the computing system 120 may require that the selected company confirm the certain percentage. Whenever the stockist of the football jerseys makes a sale, the royalty percentage is automatically transferred by the computing system 120 to the football club in block 1270.

The computing system 120 may be used to implement performance based payments. Some individual users, for example project managers, may earn rewards based mainly on job performance. After a trigger event is detected by the computing system 120 in block 1215 (see FIG. 20), performance is confirmed in block 1260 by a third party agreed upon by the parties involved. After performance is confirmed, the reward is transferred in block 1270 (see FIG. 20)

The computing system 120 may be used to distribute advertising revenue. Revenue from advertising may be taxed at different sales tax rates depending upon the country in which the advertising occurs and the size of the market. The basis of market measure may be the previous actual sales or revenue of a particular product or brand on the computing system 120. For example, the computing system 120 may charge $100 to place an advertisement for a car brand. Information necessary to determine sales tax is received by the computing system 120 in block 1210 (see FIG. 20). The computing system 120 may periodically (e.g., annually) detect a triggering event in block 1215 and determine how many sales of the relevant product(s) occurred within a predetermined time frame (e.g., the last year). Exemplary sales on the computing system 120 of the product advertised are as follows: China 30%, UK 30%, and US 40%. Exemplary sales tax rates (or other taxes) on advertising total 10% for all of the countries. Thus, in this example, in block 1270 (see FIG. 20), $3 (0.3*0.1*$100) of sales tax may be automatically apportioned and paid into the government of China.

The computing system 120 may be used to present a confirmed breakdown of production costs. When a first user seeks a quote from a second user, the first user can request a confirmed breakdown of production costs with the consent of the second user. For example, the computing system 120 may provide labor costs. The computing system 120 may determine an average labor cost from payroll data and calculate a cost per hour based on the average labor cost. The computing system 120 may provide the option of viewing the breakdown of production costs for quote using the average labor cost or actual cost of the personnel performing the tasks identified in the quote. Thus, these costs are confirmed by the computing system 120.

The computing system 120 may be used to apply for visas, including a global visa pass. For example, a particular user may apply for visas in multiple countries using the computing system 120. The computing system 120 may charge the particular user a fee per application for each pre-verification (before approval) of a visa by the applicable Ministry of Immigration or consulate. Users may apply for visas in a various countries all at once or a global visa pass. A global visa pass allows a user to file one visa application with the computing system 120. After that visa application is approved by the relevant countries (using the computing system 120), the relevant countries issue a single visa that is effective in the relevant countries. Since most of the requirements for visas are similar or uniform in most cases, users may submit proof of satisfying one requirement that may be applicable to various countries. For example, a confirmed bank statement may be submitted as proof of income. Thus, the confirmed bank statement may be applicable to various countries and only one submission of this requirement will suffice for the various countries. This saves users the costs of obtaining the confirmed bank statement multiple times and reduces administrative fees charged by the visa company because a single administrative fee will be less than the administrative fees charged when multiple visas are applied for individually.

The computing system 120 may be used to directly confirm vaccinations have been administered. The computing system 120 has a database, section, and/or tab for each approved medical center that identifies individuals and which vaccinations have been administered at the center for the individuals. This database may show the expiration dates of the vaccinations. The computing system 120 may send remainders to the individuals when the expiration date of a vaccination is close or has passed. When a user applies for a visa and one of the requirements is a vaccination, the computing system 120 searches all of the medical centers for vaccinations received by the user. If the required vaccination is located by the search, the computing system 120 submits a confirmed vaccination record to the applicable visa agency. Thus, the computing system 120 may confirm vaccinations with information obtained directly from government approved medical centers.

The computing system 120 may be used to record and track ownership (e.g., chain of title) of assets. For example, the government entity 153C may record ownership interests in particular types of assets, such as real property, vehicles, and the like. When the government entity 153C updates the chain of title of an asset (e.g., adds a new owner who replaces a previous owner), the update may be confirmed on the computing system 120 by the current and/or previous owner. Currently, some of these assets may be collateral for securing one or more loans. Operations user(s) of the relevant bank may add those assets that have been used to secure loans into the computing system 120. The owner(s) of these assets may confirm this information and the assets may be listed in the computing system 120 as being subject to the loan(s). Thus, such assets cannot be listed for sale and their ownership cannot be changed in the computing system 120. Also, the owner of such an asset may be unable to use that asset to obtain another loan.

### Entertainment

The users 110 may classify themselves in the computing system 120 as members of the entertainment industry. Those of the users 110 classified as being in the entertainment industry may also be classified into one or more of the following categories:
Actors;
Comedy;
Clergy;
Musicians;
Movies, TV, and Radio;
Visual Artists and Photographers;
Writers;
Chef/Cook;
disc jockey (“DJ”);
Newspapers, Magazines, and books;
Travel agent;
Florist;
Event Planner;
Designers;
Gambling;
Venue providers; etc.

For ease of illustration, the individuals IND1 and IND2 (see FIG. 1) classified themselves in the computing system 120 as being members of the entertainment industry. The individuals IND1 and IND2 (see FIG. 1) may be divided into two levels, level 1 and level 2. For ease of illustration, the individual IND1 is in level 1 and the individual IND2 is in level 2. The users (e.g., the individual IND1) in level 1 may sell their products and/or services directly to other users of the computing system 120. On the other hand, the users (e.g., the individual IND2) in level 2 may sell their services only through a third party (i.e., a distribution company).

To be registered as a level 1, users (e.g., the individual IND1) have to satisfy certain criteria specified in the computing system 120. Different criteria may be applied to users classified in different categories. For example, the computing system 120 may require that musicians have a minimum number of followers on social media and/or provide documents to show that the musicians have sold at least a certain minimum number of songs or albums.

The computing system 120 assigns an account (e.g., the first individual account 224) to each registered user (e.g., the individual IND1) who is classified as being in the entertainment industry and belongs to level 1. As explained above, any bank accounts (e.g., the first individual account 172A) owned by such a user (e.g., the individual IND1) may be connected to this account. Further, the account is registered in a specific country.

### Music

The users 110 will be able to upload their products to the computing system 120. For example, musicians may upload their songs and/or albums. The songs will be available on the computing system 120 for listening (e.g., streaming) and/or purchase. However, prices charged may be different for different purchasers. For example, an individual purchaser may be charged a different amount than a DJ purchaser. When a user buys products (e.g., music) from different countries using a user account on the computing system 120, the computing system 120 applies the sales tax rate of the country of the user account. As explained above, the sales tax may be paid to the relevant government account (e.g., the government treasury account 1100).

Users in countries without an income tax will have access to all of the funds earned through sales (after sales tax is paid). On the other hand, users in countries with an income tax will be able to access only a certain percentage of the funds earned through sales (after sales tax is paid). The computing system 120 immediately transfers this percentage to their user accounts (e.g., the first individual account 224), making the percentage available for use. The remaining (withheld) amount is available to pay income tax as per the user account of the registered user. For example, if the registered user registered his/her account in the United States (“US”), the computing system 120 applies US income tax rates to the user's income. The income subjected to income tax includes the percentage already made available to the user. The user may select one or more expenses from the user account that are tax deductible before the computing system 120 calculates and transfers the income tax owed.

### Live Concerts—the Organizer

Musician and other live performers may use the computing system 120 to organize events (e.g., live concerts) and monitor profitability on a real time basis. The users of level 1 may assign this function to anyone (e.g., their managers or event planners). With this function, the user (or assigned manager or event planner) may list requirements with respect to a host country, such as venue, hotel (type of stars e.g. five star), flights (whether private jet, business class, or economy), security, equipment hire, etc. Once all the requirements are listed in the computing system 120, the computing system 120 searches available options (e.g., hotels, venues, etc.) and their associated costs. The user may select and book one or more of the options using the computing system 120. With respect to a venue, the computing system 120 may display income information that includes a number of available seats in the venue. Using the number of available seats, the computing system 120 may calculate and display a minimum ticket price required to cover costs specified by the requirements entered into the computing system 120. As the tickets are sold, the computing system 120 automatically updates and displays net income (or revenue—costs).

### Live Events—the Entertainer

During live events (concerts, shows, etc.), the computing system 120 makes it possible for performers to tailor their performances according to the audience. For example, audience members of a musical concert who are users of the computing system 120 may use the computing system 120 to buy songs and/or albums. Further, the computing system 120 may include a music database for each user that includes songs and/or albums purchased by the user. When the users buy music concerts tickets, the musician will be able to identify the musician's songs and/or albums in the user's music database. However, the computing system 120 may not reveal the identities of the users. This information helps the musician decide whether to perform these songs or not perform them, for example, to promote other songs not purchased by the audience members. Also, with the consent of the users, the computing system 120 may display to the musician when fans have birthdays or anniversaries allowing the musician to make well wishes on these days to the fans. The computing system 120 may obtain this information from user information stored in the database 126 (see FIG. 1).

By way of another non-limiting example, the computing system 120 may display lists of favorite songs and or types of music of audience members to a DJ during live performances or events. However, the computing system 120 may not reveal the identities of the audience members. Similarly, when an event planner invites certain users of the computing system 120 to a private event, the DJ(s) may obtain a list of favorite songs of those invited from the computing system 120. Again, the computing system 120 may not reveal the identities of the invitees to the DJ. DJs may register with the computing system 120 after they have applied for and been granted a license by the government. When granted a license, DJs may be required to buy or rent a certain number of songs before the DJs are registered on the computing system 120 as DJs.

### Family Users (Monitoring of Minors Account)

The users 110 may each be classified as being an adult or a minor. The computing system 120 associates each minor user with one or more guardian users. At some point, a minor user will be old enough to no longer be classified as a minor user. When a minor user is no longer considered to be a minor is determined by the laws of the country associated with the user account. Thus, the definition of a minor user will be different in different countries. The settings of the user account associated with a minor user on the computing system 120 may be controlled by their respective guardian(s), depending on the laws and regulations of the relevant country. For example, the computing system 120 may allow the guardian(s) to control one or more of the following:
a. times at which the minor user may access certain programs (for example, while educational books may be accessed anytime of the day, television programs may be accessed only on certain days or only during certain times of the day); and
b. content that the minor can watch or is allowed to purchase.

### Prohibited Purchases

The computing system 120 may prevent user accounts from accessing activities not allowed in their respective countries. For example, a minor user account will not be allowed to purchase alcohol. In certain countries, certain religions, for example, prohibit the purchase of alcohol even by adults. Thus, the computing system 120 will not allow those user accounts associated with such countries to make such purchases. Nevertheless, alcohol may available for purchase on the computing system 120 as per the laws of the various countries.

### Control of Opening and Closing Times and Days

In different countries, certain regulated users or businesses (e.g., bars, liquor stores, and the like) have opening and closing times specified by law. Thus, the user accounts of such businesses will be not allowed to make sales when the regulated businesses are closed in accordance with relevant laws.

### Gambling—Lottery

Lottery companies may apply for gambling licenses with the applicable government body online using the computing system 120. If they already have a gambling license, the computing system 120 may confirm the existence of the gambling license with the applicable government body.

A lottery companies may each appoint a certain prescribed number of independent auditors on the computing system 120, which the computing system 120 confirms. Operations user(s) of each of the lottery companies set a jackpot prize amount on the computing system 120 that is approved by finance, HR, and administrative users of the lottery company. The jackpot prize amount is frozen and guaranteed by the computing system 120.

When the users place and pay for their bets (i.e., select lottery numbers and purchase lottery tickets) on the computing system 120, they will receive a confirmation and online tickets from the computing system 120. When users pay for bets (e.g., lottery tickets), the sales tax rate of their respective country will apply. There is a closing time (for example, one hour before a live drawing) when the submission of bets on the computing system 120 is closed. After the closing time, the computing system 120 will no longer except any bets. The closing time is specified on the computing system 120 and confirmed by the appropriate government body and the independent auditors. After the closing time, the computing system 120 automatically generates a non-editable report and sends the report to the independent auditors, the applicable government body for each applicable country, and the lottery company.

When the live draw is done (in the presence of the applicable parties), the operations user(s) of the lottery company uploads the winning numbers to the computing system 120, which are confirmed by the finance, HR, and administrative users of the lottery company. The numbers are also confirmed online on the computing system 120 by the independent auditors and the applicable government body for each applicable country. The computing system 120 notifies the winning user(s) online. For each winning user, the computing system 120 automatically deducts any applicable income taxes from the winning user's share of the jackpot prize amount and automatically pays the remaining funds to the winning user.

### Monitoring and Protection of Brands

The computing system 120 is configured to provide brand monitoring and protection. In this embodiment, trademark and/or copyright authorities (e.g., international offices) may be registered user of the computing system 120. Those of the users 110 with one or more brands may register those brands on the computing system 120. These registered brands may be confirmed on the computing system 120 by relevant trademark and/or copyright authorities. For ease of illustration, the second company 153B will be described as registering a brand with the computing system 120. The second company 153B may select one or more other users 110 (referred to as “confirmed brand users”) on the computing system 120 to produce products and/or provide services associated with the brand. The manufacturers may be located in one or different countries.

Confirmed brand users that provide services are confirmed by the brand owner (e.g., the second company 153B). Thus, for example, a confirmed brand user that is a rental car company and uses an international brand name (registered with the applicable trademark office(s)) may be confirmed on the computing system 120 by the brand owner (e.g., a Head Office user of the second company 153B).

For goods, confirmed brand users include only manufacturers or plants that produce the genuine goods associated with the brand. The produced goods may be tracked from a confirmed brand user to middlemen users and also to end users (or purchasers). In other words, the computing system 120 may provide both brand confirmation and tracking of goods. Both middlemen and end users are referred to as stockists. Thus, the computing system 120 may identify those of the users 110 who own and/or sell original goods associated with brands. The stockists may be confirmed (by the brand owner) as stockists of the original goods of that brand. However, only the specific product (e.g., type/size) associated with the brand and purchased by a particular stockist will be shown by the computing system 120 as being original, instead of all the products associated with that brand.

The methods used by the computing system 120 to track the goods include using quantity purchased. For example, if a stockist purchases one hundred products associated with a certain brand from a confirmed brand user, the computing system 120 will confirm only one hundred products owned or offered for sale by the stockist as original. When the stockist sells one hundred goods of that particular product without restocking that product from a confirmed brand user, the stockist will no longer be shown by the computing system 120 as a stockist of original goods of that particular product.

Some goods produced by the confirmed brand users have expiration dates that may be used to track such goods. When stockists buy products, the stockists will be able to view the products using the computing system 120. The tracking of expiration dates may assume a first-in first-out approach (i.e., those products received first will be assumed to have been issued first). This tracking may alert the stockists if any of these goods has expired (e.g., the stockist has expired goods on its shelves). For example, if a stockist buys one hundred products and the expiration date passes before all one hundred have been sold, the computing system 120 may alert the stockist that the remaining goods should be removed from the shelves and/or inventory.

The computing system 120 is configured to provide maximum brand prices. Those of the users 110 who have registered brands with the computing system 120 can specify maximum prices that can be charged for products associated with the brands. Thus, such users can set a price for different types of products that other users (stockists) sell. Once a maximum price is set, the stockists will not be able to sell the associated product on the computing system 120 for a price that is above the maximum price. The brand owners will may set different maximum prices in the different countries (e.g., according to the local costs) and in local currencies. The computing system 120 may automatically update maximum prices expressed in local currencies as exchange rates change. Optionally, the brand owners may set a maximum price in a common currency (e.g. USD) for use in one or more countries and locations. The maximum price expressed in the common currency may be used as a basis for updating maximum prices expressed in local currencies as exchange rates between the local currency and the common currency change.

The computing system 120 may be configured to track product demand. A confirmed brand user that produces products associated with a registered brand may list, for those products, raw materials and/or production costs in the computing system 120. These data may be matched by the computing system 120 to their actual costs.

For each product, the computing system 120 may estimate demand for that particular product. Alternatively, the brand owner may provide the estimated demand. The estimated demand will include the minimum number of loyal customers and an estimate of new customers. The estimate will also take into account any advertising costs. When the estimated future demand of each product is established, the estimated demand of the input materials including variant labor may be determined.

FIG. 22 is a flow diagram illustrating how the computing system 120 may implement raw material tracking. Referring to FIG. 22, in block 1410, a company A is a confirmed brand user and produces products associated with a registered brand. In block 1410, the computing system 120 estimates demand of the products. In blocks 1420-1430, the computing system 120 uses the estimate from block 1410 to estimate demand of inputs 1-3, respectively, which are first, second, and third raw materials, respectively, needed to produce the products. Then, in blocks 1440 and 1445, the computing system 120 uses the estimate from block 1420 to estimate demand of inputs 4 and 5, respectively, which are fourth and fifth raw materials, respectively, needed to produce the input 1. In blocks 1450 and 1455, the computing system 120 uses the estimate from block 1425 to estimate demand of inputs 6 and 7, respectively, which are sixth and seventh raw materials, respectively, needed to produce the input 2. In blocks 1460 and 1465, the computing system 120 uses the estimate from block 1430 to estimate demand of inputs 8 and 9, respectively, which are eighth and ninth raw materials, respectively, needed to produce the input 3. Thus, as shown in FIG. 22, the estimated demand for raw materials (e.g., inputs 1-3 determined in blocks 1420-1430) may be used to provide an estimated demand for those raw materials (inputs 4-9 determined in blocks 1440-1465) used to the produce such materials. As shown in FIG. 22, some raw materials are purchased or have components that are purchased by the producers who sell the raw materials to the confirmed brand user. The users 110 (see FIGS. 1, 16, and 19) can decide whether to use these demand estimates for their planning or not.

### Computing Device

FIG. 14 is a diagram of hardware and an operating environment in conjunction with which implementations of the one or more computing devices of the system 100 may be practiced. The description of FIG. 14 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 14 includes a general-purpose computing device in the form of the computing device 12. Each of the computing devices of FIG. 1 (including the computing systems 120, 130, and 152 and the computing devices 162) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 14 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 300-900 illustrated in FIGS. 6-12, respectively, and the methods 1000 and 1200 illustrated in FIGS. 15 and 20, respectively) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method comprising:
receiving, by a computing system, an application for one or more visas to a plurality of countries, the application having been submitted by a user, the one or more visas having a requirement in common;
obtaining, by the computing system, information necessary to satisfy the requirement; and
submitting, by the computing system, the information to the plurality of countries; and
receiving, by the computing system, approval of the application, the plurality of countries issuing the one or more visas.

2. The method of claim 1, wherein the requirement is a vaccination, and obtaining the information comprises:
searching, by the computing system, medical center records and locating a record indicating that the user received the vaccination.

3. A computer-implemented method comprising:
establishing, by a computing system, a user account for a medical center, the user account storing vaccination records;
automatically detecting, by the computing system, that a vaccination is about to or has expired using the vaccination records; and
sending, by the computing system, a notification to a user associated with the vaccination indicating that the vaccination is about to or has expired.

4. A computer-implemented method for use with a plurality of users, the method comprising:
determining, with a computing system, that a first portion of the plurality of users satisfy one or more criteria required to allow the first portion to enter into financial transactions directly with other users on the computing system, a second portion of the plurality of users comprising those users who do not satisfy the one or more criteria;
assigning, by the computing system, an account to each user in the first portion;
receiving, by the computing system, a plurality of works from the first portion;
receiving, by the computing system, a request from a purchaser for a selected one of the plurality of works, the purchaser having a purchaser account implemented by the computing system, the selected work having been received from a seller who has a seller account implemented by the computing system;
determining, by the computing system, a sales tax amount based on a price paid by the purchaser and a country associated with the purchaser account;
transferring, by the computing system, the sales tax amount to a government account implemented by the computing system; and
transferring, by the computing system, the selected work to the purchaser.

5. The method of claim 4, further comprising:
determining, by the computing system, whether the seller is subject to an income tax in a country associated with the seller account;
transferring, by the computing system, the price paid to the seller account when the computing system determines that the seller is not subject to the income tax;
withholding, by the computing system, an income tax withholding amount based on the price paid when the computing system determines that the seller is subject to the income tax, a remaining amount being the different between the price paid and the income tax withholding amount; and
transferring, by the computing system, the remaining amount to the seller account when the computing system determines that the seller is subject to the income tax.

6. The method of claim 5, further comprising when the computing system determines that the seller is subject to the income tax:
receiving, by the computing system, tax deductions identified by the seller for a period of time;
determining, by the computing system, income earned by the seller for the period of time;
determining, by the computing system, an income tax amount for the period of time based at least in part on the tax deductions and the income; and
transferring, by the computing system, the income tax amount for the period of time to a government account associated with the country associated with the seller account, the transferred income tax amount comprising at least a portion of the income tax withholding amount.

7. A computer-implemented method comprising:
receiving, by a computing system, an identification of an event organizer;
receiving, by the computing system, a list of requirements from the event organizer, the list comprising at least one requirement related to venue;
searching, by the computing system, for venues satisfying the at least one requirement;
receiving, by the computing system, a selection of one of the venues from the event organizer; and
displaying, by the computing system, a minimum ticket price required to cover costs based at least in part on a number of available seats in the selected venue.

8. The method of claim 7, further comprising
displaying, by the computing system, a net income as tickets are sold.

9. A computer-implemented method comprising:
storing, by a computing system, music data for each of a plurality of users, the music data identifying songs purchased by each of the plurality of users, the plurality of users each purchasing a ticket to an event at which an artist will perform; and
displaying, by the computing system, a list of songs by the artist included in the music data, the artist being able to use the list when deciding which songs to perform at the event, the list not identifying the plurality of users.

10. The method of claim 9, further comprising
displaying, by the computing system, a birthday or an anniversary of a particular one of the plurality of users to the artist, the artist being able to send well wishes to the particular user.

11. A computer-implemented method comprising:
registering, by a computing system, a user as a disc jockey only after the user has bought or rented a predetermined number of songs; and
displaying, by the computing system, a list of songs that are considered to be favorites of a plurality of users, the disc jockey being able to use the list when deciding which songs to play at an event to be attended by the plurality of users, the list not identifying the plurality of users.

12. A computer-implemented method comprising:
identifying, by a computing system, a user as a minor user;
associating, by the computing system, the minor user with a different guardian user;
displaying, by the computing system, options to the guardian user, the options allowing the guardian user to determine at least one of the following:
one or more times at which the minor user may view one or more types of content provided by the computing system,
content the minor user is allowed to view on the computing system, and
content the minor user is allowed to purchase on the computing system; and
receiving, by the computing system, selections with respect to the options from the guardian user.

13. A computer-implemented method comprising:
identifying, by a computing system, one or more purchases no allowed in a country of a user; and
preventing, by the computing system, the user from making at least one of the one or more purchases.

14. The method of claim 13, wherein the at least one purchase is prohibited within a time range, and the computing system prevents the user from making the at least one purchase during the time range.

15. A computer-implemented method comprising:
confirming, by a computing system, a gambling license of a lottery company, the lottery company appointing at least one independent auditor;
receiving, by the computing system, a jackpot prize amount of a lottery from the lottery company;
freezing, by the computing system, the jackpot prize amount;
selling, by a computing system, tickets to the lottery to a plurality of users;
paying, by the computing system, sales tax for the tickets;
receiving, by the computing system, a set of winning lottery numbers;
receiving, by the computing system, confirmation of the set of winning lottery numbers;
identifying, by the computing system, one or more of the plurality of users as one or more winners of the lottery based on the tickets and the set of winning lottery numbers;
unfreezing, by the computing system, the jackpot prize amount;
determining, by the computing system, an income tax portion and a remaining portion of the jackpot prize amount;
paying, by the computing system, the income tax portion to a government account; and
paying, by the computing system, the remaining portion to one or more accounts each associated with at least one of the one or more winners of the lottery.

16. A computer-implemented method comprising:
receiving, by a computing system, an identification of a brand and an associated product;
confirming, by the computing system, registration of the brand with an official authority;
identifying, by the computing system, a stockist authorized to sell the product;
identifying, by the computing system, an authorized producer that produces units of the product and sells the units of the product to the stockist for resale thereby;
displaying, by the computing system, a listing of one or more units of the product for sale by the stockist;
tracking, by the computing system, the units of the product purchased by the stockist from the authorized producer and sold by the stockist to help ensure the stockist is selling only authorized units of the product; and
removing, by the computing system, the listing when the computing system determines the stockist has sold all of the units purchased by the stockist from the authorized producer.

17. A computer-implemented method comprising:
receiving, by a computing system, identifications of products sold to a stockist, each product having an expiration date;
displaying, by the computing system, a listing of the products to the stockist;
determining, by the computing system, a selected one of the products has expired based on the expiration date of the selected product; and
alerting, by the computing system, the stockist that the selected product has expired.

18. A computer-implemented method comprising:
receiving, by a computing system, an identification of a product sold to a stockist and a maximum price for the product in at least one country;
receiving, by the computing system, a proposed listing for the product from the stockist, the proposed listing including a product price and offering the product for sale in the at least one country; and
displaying, by the computing system, the proposed listing only when the product price is less than or equal to the maximum price.

19. A computer-implemented method comprising:
estimating, by a computing system, a future demand for a product; and
estimating, by a computing system, future demands for a plurality of inputs used to manufacture the product based on the estimated future demand for the product, the plurality of inputs comprising one or more raw materials.
